(19) United States
(12) Patent Application Publication
(10) Pub. No.: US 2004/0258604 A1
(43) Pub. Date: Dec. 23, 2004

(54) Apparatus and method for nanoparticle and nanotube production and use therefor for gas storage

(76) Inventor: Vladislay Andreevitch Ryzhkov, Limassol (CY)

Correspondence Address: BLACKWELL SANDERS PEPER MARTIN LLP, 720 OLIVE STREET, SUITE 2400, ST. LOUIS, MO, 63101, US

(21) Appl. No.: 10/488,900

(22) PCT Filed: Sep. 6, 2002
(86) PCT No.: PCT/GB02/04049

(30) Foreign Application Priority Data
Sep. 6, 2001 (GB) 0121558.1
Sep. 6, 2001 (GB) 0121554.0
Sep. 29, 2001 (GB) 0123491.3
Oct. 1, 2001 (GB) 0123508.4

(51) Int. Cl. C01B 31/00

(52) U.S. Cl. 423/445 R; 423/445 B

(57) ABSTRACT

There is provided a method for the enhanced production of fullerenes, nanotubes and nanoparticles. The method relies upon the provision of a hydrocarbon liquid which is converted by a suitable energy source to a synthesis gas such as acetone, ethylene, methane or carbon monoxide, the synthesis gas(es) forming the precursors need for fullerene, nanotube or nanoparticle production. The nanotubes formed by the method described are in general terms shorter and wider than conventionally produced nanotubes. An improved apparatus for production of the fullerenes and nanocarbons is also disclosed wherein a moveable contactor is attached to a first electrode with a sealable chamber, and is spaced from the second electrode such that an electric arc can pass between them.

### APPLICATION CROSS-REFERENCES

This application claims priority of International Application No. PCT/GB02/04049 filed Sep. 6, 2002 and published in English. This application also claims priority of Great Britain Patent No. 0121558.1, filed Sep. 6, 2001, and of Great Britain Patent No. 0121554.0, filed Sep. 6, 2001, and of Great Britain Patent No. 0123491.3, filed Sep. 29, 2001, and of Great Britain Patent No. 0123508.4, filed Oct. 1, 2001.

### BACKGROUND OF INVENTION

The invention concerns the production of new carbon allotropes, namely, fullerenes, carbon nanotubes and nanoparticles (buckyonions), and also the encapsulation of such gases inside such nanocarbons (particularly nanotubes, nanohorns, nanofibers and other nanoporous carbons) for storage purposes.

Carbon nanotubes are fullerene-like structures, which consist of cylinders closed at either end with caps containing pentagonal rings. Nanotubes were discovered in 1991 by Iijima [15] as being comprised of the material deposited in the cathode during the arc evaporation of graphite electrodes. Nanotubes have now been recognized as having desirable properties which can be utilized in the electronics industry, in material and strengthening, in research and in energy production (for example for hydrogen storage). However, production of nanotubes on a commercial scale still poses difficulties.

These allotropes are among the most desirable materials for basic research in both chemistry and physics, as well as applied research in electronics, non-linear optics, chemical technologies, medicine, and others.

The processes of producing new allotrope forms of carbon, fullerenes, nanotubes and nanoparticles (buckyonions) are based on the generation of a cool plasma of carbon clusters by an ablation of carbon-containing substances, driven by lasers, ion or electron beams, a pyrolysis of hydrocarbons, an electric arc discharge, resistive or inductive heating, etc., and clusters' crystallization to the allotropes under certain conditions of annealing [1]. After which fullerenes are usually eluted from the soot by the use of aromatic solvents, such as benzene, toluene, xylenes, chlorobenzene, 1,2-dichlorobenzene, and the like [2]. Nanotubes on the other hand are separated from soot and buckyonions by the use of gaseous (air, oxygen, carbon oxides, water steam, etc.) [3] or liquid oxidants (nitric, hydrochloric, sulfuric and other acids or their mixtures) [4].

The processes of forming different carbon allotropes (for instance, fullerenes and nanotubes/buckyonions) are competitive and, therefore, it is possible to displace the balance in their output by changing conditions either of the generation process or of crystallization (annealing). In arc discharge processes, increasing the pressure of a buffer gas (He or Ar) from 50-150 Torr, which is optimal for producing fullerenes, to 500 Torr leads to a preferential formation of Multi-Wall Nano Tubes (MWNT)/onions [5,9]. Addition of some metal catalysts (Co, Ni, Pt, Fe, etc.) to the initial graphite donor leads to preferential formation of Single-Wall NanoTubes (SWNT)[6] with a yield up to 70% for laser ablation of the graphite. Despite outstanding results obtained with laser ablation [1], one can conclude that any process and apparatus based on laser ablation is not commercially viable because of the very low coefficient (few %) of transformation electric energy to energy deposited into vaporized targets.

Processes for producing lower and higher fullerenes (that is, all fullerenes except C₆₀ and C₇₀) are less well developed than equivalent processes for producing the classical bucksminsterfullerenes, C₆₀ and C₇₀. The main problem is a very low yield of the lower and higher fullerenes. For C₇₄, C₇₆, C₇₈, and C₈₄ the yield is usually about 1-3% and less than 0.1% for C₉₀, C₉₄, C₉₈ in comparison to the yield of 0-40% for the classical fullerenes [6]. For lower fullerenes, the yield is even lower. As a result, the amounts of such fullerenes available are too low to study their general properties.

The existing methods and devices for producing fullerenes [7] suggests that graphite electrodes are placed in a contained volume filled by He gas at a pressure of 50-150 Torr. Under certain conditions (electric current is up to 200 Å and voltage in the range 5-20 V), the graphite anode is evaporated and evaporated graphite clusters can form fullerene molecules, mainly C₆₀ (80-90%) and C₇₀ (˜10-15%) as well as small amounts of higher fullerenes (total sum not exceeding 3-4%). High Performance Liquid Chromatography (HPLC) is then required to separate individual fullerenes [8].

HPLC is characterized by a very low production of higher fullerenes and, as a result, market prices of the higher fullerenes are enormous, more than $1,000-10,000 per gram. Higher order fullerene mixtures are produced by column chromatography in toluene, then are precipitated as a microcrystalline powder. The mixture contains varying amounts of C₇₆ through C₉₆, but mainly C₇₆, C₇₈, C₈₄, and C₉₂.

Therefore, usual inert gas arc methods are useless for producing higher fullerenes. Outputs of C₇₆, C₇₈, C₈₄ from such technologies are about a couple of milligrams a day per processor, whereas for lower fullerenes the outputs are even less.

It is obvious that a preferential production of lower/higher fullerenes over classical ones, C₆₀ and C₇₀, will help in solving the problem.

Modak et al. [10] occasionally produced a mixture of C₆₀ with hydrides of lower (C₃₆, C₄₀, C₄₂, C₄₄, C₄₈, C₅₀, C₅₂, C₅₄, C₅₈) and higher (C₇₂, C₇₆) fullernes by using a high-voltage AC arc-discharge in a liquid benzene and/or toluene medium. An electric field of the order of 15-20 kV was passed through the graphite electrodes whose pointed tips were immersed in the liquid. After removal of non-dissolved black (soot) particles by filtration, vacuum evaporation of the treated liquids and washing (HPLC) with ether resulted in the isolation of red solids which were analyzed by mass spectroscopy showing a presence of fullerenes in the range from C₅₀ to C₇₆. The dominant fullerene molecules were C₅₀Hₓ, whereas contents of C₆₀ and C₇₂Hₓ, C₇₆Hₓ were comparable but 3-8 times less than that of C₅₀Hₓ.

However, neither fullerenes greater than C₇₆, nor nanotubes/nanoparticles were produced this way. The process also consumes a lot of electric energy as the high-voltage arc is used. Under such arcing, tips of the electrodes are “exploded” causing graphite or metallic (if metallic electrodes are used) debris in the products.

The great disadvantage of this methodology is that the process is not self-regulated. In such a device the tips of the electrodes will be destroyed after few “explosions”. One has to perform an arc through a certain gap and to check the gap during the process as the anode tip is consumed.

In observing Modak's method a safety problem arose because of the release of huge amounts of gases in the process of cracking benzene/toluene. Another problem of the Modak method is that there are no means (for example, an additional buffer gas with the exception of gaseous hydrocarbons released under cracking the liquids) for regulating/controlling the cracking process to provide the desired composition of the fullerenes or to produce nanotubes/nanoparticles. As a result, HPLC is required to separate the fullerene mixture to individual species.

The basic method for producing MWNT/buckyonions [5, 9] using a DC arc discharge of 18V voltage between a 6 mm diameter graphite rod (anode) and a 9 mm diameter graphite rod (cathode) which are coaxially disposed in a reaction vessel maintained in an inert (helium at pressure up to 500-700 Torr) gas atmosphere has a problem because it is not possible to continuously produce carbon nanotube/buckyonion deposits in large amounts because the deposit is accumulated on the cathode as the anode is consumed. It is required to maintain a proper distance (gap) between the electrodes.

Oshima et al. [11] suggest a complicated mechanism for maintaining the gap (preferably in the range from 0.5 to 2 mm) between the electrodes at the same DC voltage (preferably 18-21 V)/current (100-200 Amp) and for scraping the cathode deposit during the process. As a result, they are able to produce up to 1 gram of a carbonaceous deposit per hour per one apparatus (pair of electrodes). A nanotube/buckyonion composition of the deposit is supposed to be the same as in [5, 9], i.e., nanotube: carbon nanoparticles (buckyonions) 2:1. A specific consumption of electric energy is about 2-3 kW-hour per one gram of the deposit. Complexity of the device, high specific energy consumption plus consumption of the expensive inert gas, helium, are the most important factors that restrain bulk production of MWNT/buckyonion deposits by this method.

Instead of these methods, to produce nanotubes in bulk Olk [12] suggests simplifying a DC arc discharge, device by immersing carbonaceous electrodes in a liquefied gas (N₂, H₂, He, Ar or the like). The other arc parameters are nearly the same (18V-voltage, 80 Amps-current, 1 mm-gap, 4-6 mm in diameters-electrodes). However, such a “simplification” leads to even poorer results than those in the methods mentioned above. It was possible to maintain an arc between the electrodes for just 10 seconds, and therefore the production was very low. The composition of the deposit was nearly the same as in the previous methods.

To improve properties of the said deposits they suggest purifying and uncapping MWNTs [3,4] by using gaseous/liquid oxidants and filling the uncapped nanotubes with different materials (metals, semiconductors, etc.) to produce nanowires/nanodevices. Tips of nanotubes are more reactive than side walls of buckyonions. As a result of oxidation only carbon nanotubes are finally left while buckyonions disappear.

Recently, it has been discovered that buckyonions are very promising material to produce diamonds. However, known processes produce less buckyonions than nanotubes and purifying the deposit by using known methods leads to a complete reduction of buckyonions. Therefore, it is required to find an improved process for producing or purifying buckyonions.

It is required to uncap nanotubes to fill them with metals (to produce nanowires) or other substances, like hydrogen (to create a fuel cell).

The main problem in uncapping the tubes by known methods is supposed to be that under the oxidation the tube ends become filled with carbonaceous/metallic debris that complicates filling the open-ended tubes with other materials after oxidation, finally reducing an output of the filled nanotubes.

Chang suggests a method of encapsulating a material in a carbon nanotube [13] in-situ by using a hydrogen DC arc discharge between graphite anode filled with the material and graphite cathode. The main difference from the above mentioned methods is the use of a hydrogen atmosphere to provide conditions for encapsulating the material inside nanotubes during the arc-discharge, i.e., in-situ. All the arc discharge parameters are nearly the same as in the above mentioned processes (20V-voltage, 100 Amp-current, 150 Å/cm²-current density, 0.25-2 mm-gap, 100-500 Torr-pressure of the gas). The presence of hydrogen is thought to serve to terminate the dangling carbon bonds of the sub-micron graphite sheets, allowing them to wrap the filling materials. Judging by TEM examination of the samples produced by this method, about 20-30% of nanotubes with diameters of approximately 10 nm are filled with copper. The range of germanium filled nanotubes is 10-50 nm and their output is much lower than that of the copper filled nanotubes. Use of a helium atmosphere (at the same pressure in the range of 100-500 Torr) instead of hydrogen leads to a preferable formation of fullerenes, copper or germanium nanoparticles and amorphous carbon (soot particles) with no nanotubes at all. A mixture of hydrogen and an inert (He) gas may be used for the encapsulation as well.

Shi, et al. [14] have reported mass production of SWNTs by a DC arc discharge method with a Y-Ni alloy composite graphite rod as anode. A cloth-like soot is produced, containing about 40% SWNTs with diameter about 1.3 nm. The most important feature of this invention is the addition of Y-Ni alloy in the anode. However, the yield of the deposits and specific energy consumption are nearly the same as in the methods described above.

A major drawback to these prior art processes is the low quantity of non-classical fullerenes, nanotubes and buckyonions produced. Typical production rates under the best of circumstances using these processes amount to no more than 1 g/hour of a carbonaceous deposit containing for 20-60% of nanotubes and 6-20% of buckyonions. Furthermore, the prior art processes are not easily scaled-up to commercially practical systems.

### SUMMARY OF INVENTION

In WO-A-00/61492, the applicants describe a device and method for producing higher fullerenes and nanotubes. The apparatus described in this application comprises a sealed chamber containing opposite polarity carbon (graphite) electrodes. The first electrode (electrode A) consists of a graphite pipe which is installed in vertical cylindrical openings of the cylindrical graphite matrix that forms electrode B. A free moving spherical graphite contactors is positioned above electrode A. Once an electric current is switched on, the contactor causes arcing at the electrodes. Because the contactor is free to move, the apparatus provides an auto-regulated process in which the contactor oscillates during the arcing process. The pulsed character of this oscillation provided an optimum current density and avoids saturation of the arc gap by gaseous products. This apparatus represents a significant increase in yields in comparison to the known prior art.

It is a further object of the present invention to provide a further improvement to the apparatus and method disclosed in WO-A-00/61492.

In the method of WO-A-00/61492, the electrodes of the arc discharge are graphite and it was believed, in accordance with the understanding in the art at that time, that these electrodes acted as a carbon source for production of the fullerenes and nanotubes. Erosion of the electrodes during operation of the process was observed and this reinforced the view.

We have now found, however, that provided the hydrocarbon liquid produces so-called “synthesis” gases (such as acetylene, ethylene, methane, or carbon monoxide) under the reaction conditions, that those gases will act as an effective carbon source and precursor for production of the nanotubes and nanoparticles.

Thus, a new process and apparatus is required for producing carbon nanotubes and nanoparticles (especially non-classical fullerenes and buckyonions) in bulk.

Further, single Wall Nano Tubes (SWNTs) produced by laser ablation [16] of carbonaceous targets mixed with metallic catalysts (usually, Co and Ni) typically have rope-like structures of undefined length and diameters of 1-1.4 nm. For some applications it is required to cut SWNTs to shorter (100-400 nm in length) pieces [17].

SWNTs produced by an electric arc discharge between graphite electrodes containing metallic catalysts such as Ni and Y have bigger mean diameters of 1.8 nm and unlimited lengths [18].

Multi Wall Nano Tubes (MWNTs) typically have several concentrically arranged nanotubes within the one structure have been reported as having lengths up to 1 mm, although typically exhibit lengths of 1 micrometers to 10 micrometers and diameters of 1-100 micrometers and diameters of 2-20 nm [15]. All of the methods described in the literature to date report nanotubes of these dimensions.

We have now discovered a methodology which produces shortened nanotubes (sh-NTs), making these nanotubes more suitable for certain applications.

The present invention provides a process and apparatus for producing fullerenes, carbon nanotubes and nanoparticles in much larger quantities than has been possible before. The invention can be scaled up to produce commercial quantities of the fullerenes, nanotubes and nanoparticles, such as buckyonions.

Accordingly, the present invention provides a method for producing fullerenes, nanotubes or nanoparticles, said method comprising;

a) providing a hydrocarbon liquid as an effective carbon source; and

b) providing energy input, such that said hydrocarbon liquid produces acetylene, ethylene, methane or carbon monoxide.

Preferably, the energy input can be any of the following:

electric arcing; resistive heating; laser; electron beam; or any suitable beam of radiation. The energy input has a key-role in triggering and controlling the element cracking of liquid hydrocarbons, providing conditions for optimal production of the “synthesis” gases (i.e. acetylene, ethylene, methane or carbon monoxide), and thus for optimal production of the nanotubes and/or nanoparticles.

The hydrocarbon liquid may be any suitable hydrocarbon liquid and may even be a mixture of different liquids. Mention may be made of cyclohexane, benzene, toluene, xylene, acetone, paraldehyde and methanol as being suitable hydrocarbon liquids. Optionally the hydrocarbon liquid is an aromatic hydrocarbon liquid.

Preferably, the aromatic hydrocarbon liquid contains pure aromatics and mixtures of aromatics with other liquid hydrocarbons, for instance, Co—Ni-naphtenates based on toluene solutions or toluene solutions of sulphur (which is considered to be a promoter of the growth of SWNT), etc.

In this invention, we suggest an auto-regulated low-voltage contact electric (AC or DC) arc discharge as a good energy source.

To produce fullerenes, it is preferable to create conditions for producing polycyclic aromatic hydrocarbon (PAHC) precursors of the fullerenes and for their interactions with each other to form fullerenes (see Example 1).

The production of fullerenes is enhanced by using selection of the geometry of the electrode system, type of the aromatic hydrocarbon, electrode material, the presence of a buffer gas.

To produce nanotubes/nanoparticles, it is preferable to create optimal conditions for continuously producing deposits (the longer, the better) with a minimum consumption of electrical energy. More preferably an optimal voltage or type of anode can be specified for optimal production of desirable products, for example, lower or higher fullerenes, SWNTs or MWNTs or buckyonions.

Cracking aromatic liquids provides the lowest specific energy consumption.

By cracking aromatic-based liquids it is possible to form a very wide range of said PAHC precursors. However, under certain preferable conditions just a few PAHCs are most stable. Therefore, interacting (coagulating) with each other, they can form just a few possible combinations of carbon clusters which are annealed to a few different fullerenes. For example, in some aromatic (for instance, benzene) flames the most stable PAHC species are the following three: C₁₆H₁₀, C₂₄H₁₂ and C₃₈H₁₄. If one provides conditions for plasma-chemical interactions (coagulation) between two of these most stable polycyclic precursors, only six variants of the coagulation will be possible.

These six reactions are able to produce following fullerenes:

C₁₆H₁₀+C₁₆H₁₀ 1.

→C₂₈+2C₂+5H₂

→C₃₀+C₂+5H₂

→C₃₂H₂+4H₂

C₁₆H₁₀+C₂₄H₁₂ 2.

→C₃₈+C₂+11H₂

C₂₄H₁₂+C₂₄H₁₂ 3.

→C₄₄+2C₂+12H₂

→C₄₆+C₂+12H₂

C₃₈H₁₆+C₁₆H₁₀ 4.

→C₅₀+2C₂+13H₂

→C₅₀(CH₂)₂+C₂+11H₂

→C₅₀(CH₂)₄+9H₂

C₃₈H₁₆+C₂₄H₁₂ 5.

→C₆₀+C₂+14H₂

C₃₈H₁₆+C₃₈H₁₆ 6.

→C₇₄(CH₂)₂+14H₂

C₇₆H₄+14H₂

One can see that if one of said precursors is reduced, it will cause a reduction or disappearance of corresponding fullerenes, for instance, for C₂₄H₁₂ the corresponding fullerenes are C₃₈, C₄₄, C₄₆ and C₆₀. Therefore, if formation of C₂₄H₁₂ is suppressed, production of C₆₀ and C₃₈, C₄₄, C₄₆) will be suppressed as well.

Moreover, one can see that it is possible to form some fullerenes preferentially, by providing conditions for a formation of a single precursor. For instance, C₇₄(CH₂)₂ or C₇₆H₄ might be produced preferentially, if C₃₈H₁₆ is the most abundant PAHC species. Further, if proper conditions are provided to coagulate said fullerenes (or most probably their carbon cluster precursors), it will be possible to form fullerenes higher than C₇₆ using plasma-chemical interactions as following:

C₅₀+C₅₀

→C₉₈+C₂

C₅₀+C₅₀(CH₂)₂

→C₉₈+C₂+2CH₂

C₅₀+C₅₀(CH₂)₄

→C₉₈+C₂+4CH₂

C₅₀(CH₂)₂+C₅₀(CH₂)₄

→C₉₈+C₂+6CH₂

C₅₀(CH₂)₄+C₅₀(CH₂)₄

→C₉₈+C₂+8CH₂

C₆₀+C₆₀

→C₁₁₈+C₂

C₇₆H₄+C₇₆H₄

→C₁₅₀+C₂+4H₂

C₇₄(CH₂)₂+C₇₄(CH₂)₂

→C₁₄₈+4CH₂, etc.

If C₅₀ is the most abundant fullerene species, C₉₈ will be the highest fullerene species produced.

Thus, we suggest varying the fullerene composition by adjusting conditions for preferential formation of PAHC precursors and their interaction with each other. The main features are the use and pressure of a buffer gas as well as varying the composition of the liquid and/or composition of the electrodes, varying the type and voltage of applied electric current.

Further adjustment of the cracking allows performance of a process for continuously producing nanotubes and nanoparticles.

All organic liquids are dielectrics, therefore, there is a threshold voltage for starting an electric arc discharge in the liquids and this threshold varies depending on the geometry of the electrodes.

Thus, in the case of an electrical energy source, a range of applied voltage for optimal production has been determined. Preferably, the voltage used in nanotube production is in the range 18 to 65V. More preferably the voltage used in nanotube production is 24V to 36V. More specific energy values are preferred to form SWNTs (with smaller diameters), buckyonions and, especially, fullerenes rather than MWNTs. Therefore, applied voltages for optimal production of MWNTs should be a bit less than for buckyonions and fullerenes.

As the arc is used as the trigger/controller, the electrodes may be constructed of any suitable material in any shape, for instance, graphite or metallic anodes in the shape of rectangular or triangular prisms, whole or truncated cylinders, flat discs, semi-spheres etc. placed inside cylindrical or square openings of the graphite, brass or stainless steel matrices.

Preferably the electrode material should be electrically conductive and selected to withstand high temperatures in the order of 1500-4000° C.

Preferably the electrode material is graphite. Graphite is a cheap solid carbonaceous material and is therefore preferred for making electrodes. Refractory metals, such as tungsten and molybdenum, may be used to form electrodes. The cathode material may be selected from usual construction materials, even materials such as brass and stainless steel. These materials are particularly useful when a DC arc is being applied.

As one of the electrodes is movable, an electrical arc between the two electrodes may be started by causing the two electrodes to touch each other, either before or after application of an electrical voltage to one of the electrodes, and then the electrodes are separated to a pre-determined gap due to gases released in the cracking process after the electrical current is flowing through the electrodes.

The amount of voltage necessary to produce an arc will depend on the size and composition of the electrodes, the length of the arc gap, and the ambient medium (the liquid). Hydrocarbon liquids are most preferred.

The electrical power source may provide either alternating or direct voltage to one electrode.

A buffer gas provides for promotion of optimal condensation of carbon clusters to fullerene, nanotube and nanoparticle molecules. Generally speaking, in our process the buffer gas is mainly composed of gases released under the cracking, i.e., mainly of acetylene and hydrogen with admixtures of ethylene, methylene, ethane and methane. Thus, typically no additional buffer gas flow is required to produce said carbon allotropes. However, impressing additional buffer gases allows control of the composition of the buffer gas and its flow over the electrodes to the arc gaps and, finally, it allows control of the composition of the carbon allotrope products.

Preferably said additional buffer gas is an inert gas. More preferably said inert gas is argon.

Argon promotes arcing and processes of formation of higher fullerenes and nanotubes. When producing fullerenes, argon (as well as some oxidants, like O₂, air, etc.) suppresses undesirable PAHC precursors and promotes production of the desirable higher fullerenes. Thus, we found that by increasing argon flow it is possible to suppress PAHC C₂₄H₁₂ production, one of the precursors of the fullerenes. Suppression of this precursor leads to a dramatic reduction in the production of C₆₀ and some lower fullerenes and allows the production of mainly C₉₈. Separation of the main fullerene admixture C₅₀ is achieved by filtration through Molecular Sieves (see Example 1). Oxidants, like air or oxygen, may be useful to reduce some fullerene precursors and to modify nanotube/nanoparticle structures.

Halogens (fluorine, chlorine and bromine) may be useful for producing halogenated fullerenes and nanotubes.

However, all the additional gases except noble gases may be withdrawn as they may be produced under cracking of the aromatic liquids.

Preferably, the pressure above the liquid is pre-selected and controlled. During the cracking process, gaseous products are released and these gaseous products expand a gaseous (annealing) zone around the arc gap reducing optimal densities of carbon vapor, acetylene and other buffer gases. If the pressure above the liquid is selected to be a predetermined optimum value, the annealing (gaseous) zone will be optimized and fullerene, nanotube/nanoparticle production will be optimised.

Selecting the correct pressure above the liquid allows an increase an electric current through an arc gap without breaking the gap. However, if the pressure is too high the gap will be shorter than is required for optimal production.

Preferably an auto-regulated valve is used to release gases from the body and to maintain an optimal pressure.

Preferably the pressure above the liquid is between 0.8 atm and 1.0 atm. Due to the limit of pressures at which fullerenes, nanotubes and nanoparticles can be produced in sufficient quantities, the process is preferably carried out inside a hermetically sealed body or chamber. The space over the hydrocarbon liquid in the body may be evacuated by means of a vacuum pump. After the space has been evacuated, it may be partially refilled with the desired atmosphere such as a noble gas or any suitable gas mixture. More preferably, argon is used.

The hermetically sealed body is preferably constructed of stainless steel. Opposite-polarity electrodes are placed within the body. An electrode with a smaller cross section (electrode A—anode in the DC arc) may be made as an elongated rod or pipe made of carbonaceous materials (graphite) or refractory metals, preferably of Mo or W, one ending of this rod or pipe is connected to a power supply, and a moveable graphite or metallic contactor (electrode C) suitable for starting the arcing is connected to another ending. This contactor is close to a surface of another opposite-polarity electrode with a bigger cross-section (electrode B—cathode in the DC arc).

The current feedthrough passes through a wall of the body but is insulated from the electrical conductor so that there is no electrical contact between the electrical current source and the body. The opening in the body through which current feedthrough passes is sealed by a seal to prevent either passage of the outside atmosphere into the body or leaking of gas from the body.

Electrical contact between electrode A and an electrical conductor may be made by any means which will provide electrical conduction between the two.

An insulator provides electrical isolation of the electrodes from the body. The insulator also provides a seal to keep the body isolated from the outside atmosphere.

Using a free (self-movable) contactor (electrode C) allows the desired gap for the electric arc to be set at a nearly constant value since the electrodes are consumed during production of fullerenes, nanotubes and nanoparticles.

To start the apparatus, opposite-polarity electrodes should be adjusted to barely touch. At this time, with the electrodes touching, the electrical voltage source should be activated to apply voltage to electrode A in an amount sufficient to cause an electrical current to flow from electrode A to electrode B. After the current flows, the electrodes are separated automatically because of the gases released under cracking of the liquid, cause the desired arc gap to be produced. In practice, the gap may be very small and the electrodes may appear to touch so that the arc may be described as a “contact arc”.

When producing fullerenes, the duration of the production (0.5-8 hours) depends on solubility of a produced fullerenes in the treated liquid. In pure aromatic liquids and their mixtures most of the produced fullerenes will be dissolved into the liquid. However, as soon as soot particles appear in the liquid in sufficient quantity the soot particles will adsorb nearly a half of the produced fullerenes. Therefore, using pure aromatic liquids requires extraction of the fullerenes from both fractions, the liquid and the soot.

Increasing the operational time beyond 8 hours does not lead to a proportional increase in the fullerene output because of the destructive and synthetic processes also occurring in the process.

Such a proportional increase of the output is only possible if the fullerenes are accumulated in the soot particles. If solubility of the fullerenes in the treated liquid is very low, the fullerenes will be forced out of solution by species having better solubility (for instant, PAHCs), so that the fullerene molecules will be continuously adsorbed by soot particles and precipitated to the bottom of the body, preventing their decomposition by the process. This allows operation of the process for an unlimited time, accumulating the fullerenes adsorbed by soot on the bottom of the body and, afterwards, isolating them from the soot using certain washing and extraction procedures. However, cracking liquids exhibiting low solubility of fullerenes (like acetone, methanol, etc.) do not produce fullerenes with an output that is high enough for research and industrial applications.

Therefore, we suggest that the operational time when producing fullerenes should be limited to the time when the liquid becomes saturated by PAHCs.

Afterwards, the treated liquid must be filtered using any suitable technique to separate the liquid from soot. Whatman filters or their equivalent can be used for this. As the most abundant species in the liquid and soot are PAHCs, one must remove/reduce them by any suitable washing means before isolation of the fullerenes. The liquids must be first dried in vacuum or in the atmosphere of an inert gas, like argon, N₂, CO, CO₂. The liquids' and soot residues are then washed with any suitable multisolvent, for instance, with methanol and/or acetone, which are characterized by the lowest solubility for fullerenes and by high solubility for PAHCs.

Then fullerenes must be isolated from the liquid and soot by using any suitable eluent, for instant, aromatic liquids, like benzene, toluene, xylenes, chlorobenzenes, etc. The most preferable are toluene, o-xylene and chlorobenzene.

Then one must use any suitable filtration of the eluents through a suitable nanopored material, most preferably filtering the eluents through 8/10 Å molecular sieves, to separate higher fullerenes from lower fullerenes effectively.

The lower fullerenes might then be eluted from the molecular sieves by using any suitable non-polar dissolvent, like aromatics, CS₂, etc.

For producing nanotubes/nanoparticles, the process may be continued until the deposits have grown over the whole of the elongated electrodes, at which time the electrical voltage may be withdrawn automatically by using safety wires or any other suitable sensor.

Separation of carbonaceous deposits from the electrodes may be made mechanically, for instance by scraping deposits from the electrode surface.

Separation of nanotubes/nanoparticles from amorphous carbon may be made by a “soft” oxidation in air at a temperature of about 350° C. for several hours (12-24 hours). For bulk samples such a procedure prevents overheating of the samples because of the huge energy released by oxidation of soot particles. Then metals might be removed by careful treatment with inorganic acids (HNO₃, HCl, HF, H₂SO₄ or mixtures of such acids) at room temperature (to prevent oxidation of the spherical ends of the nanotubes and filling the opened nanotubes with metal-containing acid solution), decanting the nanotube/nanoparticle residue and washing the residue with water. Afterwards, carbon nanoparticles (onions) might be oxidized in air at 535° C. for several (normally, 1-4) hours.

Uncapping nanotubes might be achieved by oxidation in air at higher temperatures, normally at 600° C., for 1-2 hours.

Hydrocarbon and carbonaceous debris at the opened ends might be removed by further oxidation in air at 535° C. for a few minutes, coupled to heating in atmosphere of inert gas (most preferably in argon) and then in vacuum. Desirably, filling-the treated nanotubes with required material (for instance, with hydrogen) should be coupled to all these abovementioned procedures, i.e. it should be done in the same cell after heating the sample in vacuum.

As stated above, our new methodology enables shortened nanotubes (sh-NTs) to be provided and these shortened nanotubes are especially suitable for certain applications.

The present invention provides shortened SWNTs (sh-SWNTs) having diameters distributed in the range 2-5 nm. Preferably, the sh-SWNTs have diameters in the range 2-3 nm.

Preferably, the sh-SWNTs have lengths in the range 0.1 to 1 micrometers. More preferably, the shortened nanotubes have lengths in the range 0.1 to 0.5 micrometers.

Consequently, the sh-SWNTs of the present invention are much shorter in length, but are of wider diameter than conventional SWNTs.

In accordance with a further aspect of the present invention there is provided shortened Multi-walled nanotubes (sh-MWNTs) having a mean diameter of 2 to 15 nm and a length of between 50 and 1000 nm.

Preferably, the sh-MWNTs have a diameter with median value of 60 to 80 Angstroms and a length of 100 to 300 nm.

Preferably, the sh-MWNTs are constructed from 2 to 6 layers of SWNT, usually 2 or 3 layers of SWNT.

Thus, the sh-MWNTs according to the present invention are much shorter than those previously described in the literature.

Powder samples of the sh-MWNTs and sh-SWNTs demonstrate relatively high electron emission at low electric fields of the order of 3-4V/micrometer. Electron emission starts at about 2V/micrometer in sh-MWNT samples.

Unexpectedly, we have found that opening a single end of our novel nanotubes is easier to perform than in respect of existing conventional nanotubes.

Additionally resealing the nanotubes of the present invention is simpler to perform than with conventional nanotubes.

The hydrocarbon liquid used to produce the sh-MWNTs of the present invention may be any suitable hydrocarbon. For example the liquid may be based on cyclohexane, benzene, toluene, acetone, paraldehyde, methanol, etc., or may be a mixture thereof.

In accordance with the present invention there is provided an apparatus for producing fullerenes, nanoparticles and nanotubes (in particular sh-NTs, sh-MWNTs and sh-SWNTs), the apparatus comprising a chamber capable of containing a liquid hydrocarbon reactant used to produce fullerenes, nanoparticles and nanotubes, said chamber containing at least one electrode of a first polarity and at least one electrode of a second polarity, said first and second electrodes being arranged in proximity to one another and wherein a contactor is fixedly attached to said first electrode.

The spacing of the electrodes should be such that an electric arc can pass between them.

Preferably, voltage applied across said first and second electrodes may be a direct voltage or an alternating voltage.

Preferably the direct voltage is in the range 18-65 Volts.

Preferably the alternating voltage is in the range 18-65 Volts rms.

Preferably the contactor is made from graphite, but may optionally, be made from tungsten or molybdenum.

Preferably said contactor is spherical in shape.

Optionally said contactor is hemisherical in shape.

Optionally said contactor may be prismic with triangular or square cross sections, cylindrical or truncated cylindrical or flat.

Metallic contactors may also be constructed from a rectangular shape of Ti-sponge or Al cylinders

Preferably said first electrode is constructed from tungsten, but optionally the first electrode may be constructed from molybdenum or a carbon containing material such as graphite.

Preferably said first electrode is rod-shaped.

Preferably, the second electrode consists of a matrix having a plurality of cavities capable of receiving the first electrode.

Preferably, the apparatus contains a gas inlet to allow gas to be supplied to the area at or near the electrodes.

Preferably, said gas is a noble, rare or inert gas.

Preferably, said gas is argon.

Preferably, said apparatus contains cooling means which may, for example, consist of a cavity wall in the wall of the chamber through which a coolant is circulated. The temperature of the coolant should be below that of the contents of the chamber.

Preferably, said chamber contains pressure regulation means for maintaining the pressure inside the chamber at a pre-determined level.

More preferably said desired pressure level is 0.8 to 1.0 atmospheres.

A. C. Dillon et al. [17] described a method of Hydrogen Storage in carbon Single Wall Nanotubes (SWNT) with a total uptake up to 7% wt for mg-scale samples. They produce 50 wt % pure SWNTs with a yield of 150 mg/hour (about 1.5 g a day for one installation) using a laser ablation method. SWNTs diameters are estimated between 1.1-1.4 nm. The method involves refluxing a crude material in 3MHNO₃ for 16 h at 120° C. and then collecting the solids on a 0.2 micron polypropylene filter in the form of a mat and rinsing with deionised water. After drying, the carbon mat is oxidised in stagnant air at 550° C. for 10 min, leaving behind pure SWNTs (98 wt %). Purified 1-3 mg samples were sonicated in 20 ml of 4M HNO₃ with a high energy probe for between 10 min and 24 hours at power 25-250 W/cm to cut the SWNTs to shorter fragments. The ultra-sonic probe used is partly destroyed during the process, spoiling SWNT's with metallic particles.

Then about 1 mg of the dried sample of the cut SWNTs is annealed in a vacuum of 10⁻⁷ Torr at 550° C. for several hours and after cooling to room temperature it is charged with hydrogen at ambient pressure. Despite such an outstanding result as 7 wt % hydrogen uptake, one can see that the method is practically useless for bulk quantities of nanotubes because of the small amounts of raw material used, huge erosion of an expensive ultra-sonic probe and difficulties of a vacuum annealing which would occur if bulk samples were used.

C. Liu et al. describes a method [18] for hydrogen storage in SWNT's with bigger diameters (up to 1.8 nm) at room temperature and moderate pressures (about 110 atm) with a total uptake of 4.2 wt % for 0.5 gram-samples. The SWNTs samples were prepared using hydrogen arc-discharge process yielding about 2 g/hour of 50-60 wt % pure SWNTs. The SWNTs samples were then soaked in HCl acid (to open nanotubes) and then heat treated in vacuum at 500° C. for two hours (to remove carbonaceous debris, hydrocarbons and hydroxyl groups at the opened ends). Hydrogen uptake was estimated on the basis of the pressure changes during storage (about 6 hours). After the samples were returned to ambient pressure, some of the hydrogen (21-25 rel %) was not desorbed from nanotubes at room temperature. After applying a vacuum heating at 150° C. the hydrogen was completely released from the nanotubes. In comparison to Dillon's method this method is much more productive. However, reliable vacuum heating of bulk quantities of the nanotubes is still problematic.

The most critical limitation for hydrogen storage in nanocarbons is the virtual impossibility of annealing hydrocarbons and carbonaceous debris at opened ends of nanopores in vacuum, especially if bulk quantities of the nanocarbons are treated on an industrial scale.

In accordance with the present invention there is provided a method of encapsulating a gas in a nanocarbon sample, the method comprising the steps of oxidizing the nanocarbon sample in order to purify the nanocarbons as much as possible and open at least one end of the nanotubes in the sample; and

impressing said gas into the nanotube.

Generally, the nanocarbon sample is oxidised at an elevated temperature, preferably not greater than 550° C. to oxidize metals and the metal carbides to their oxides. Most preferably the nanocarbon sample is oxidised at a temperature of between 350 and 650° C., typically approximately 535° C. for SWNTs or at a temperature of about 600° C. to open the spherical ends of the shortened MWNTs (sh-MWNTs) nanotubes. Alternatively, the nanocarbon sample is oxidised at ambient temperature in acids to remove metallic oxides. Ideally, the nanocarbon sample is oxidised in air, typically for between 30 and 120 minutes and preferably for between about 60 and 90 minutes.

In one preferred embodiment of the invention, the nanocarbon sample is oxidised in a three-step process comprising a first oxidation step and a second oxidation step. Typically the first oxidation step is carried out at an elevated temperature, preferably not lower than 500° C., more preferably between 520 and 550° C., typically approximately 535° C. for a time of between 30 and 90 minutes, ideally about 60 minutes. Typically, the second oxidation step is carried out at room temperature by soaking the nanocarbon samples in acids, preferably either in hydrochloric acid, hydrofluoric or nitric acids or mixtures thereof, for preferably between 10 to 24 hours. Typically the third oxidation step is carried out at a temperature of about 600° C. (for example 550 to 650° C., more preferably 580 to 620° C.) for between 30 and 120 minutes, preferably between 60 and 90 minutes. Ideally, the first and third oxidation steps are carried out in air.

Preferably, the nanocarbon sample is re-heated in air prior to purging of the nanocarbon in vacuo. Typically, the re-heating step is carried out at a temperature of preferably greater than 500° C., more preferably between 520 and 650° C., typically approximately 535° C. for a short time, such as for example about 3 minutes. Typically, the nanocarbon sample is purged in vacuo prior to impression of the gas into the nanocarbon. Alternatively, the re-heating step can be carried out in an atmosphere of any inert gas, most preferably in argon.

In one embodiment of the invention, noble gases like argon, krypton, xenon or their radioactive isotopes are impressed into the nanocarbons. In such instances, the gases will generally be at an initial pressure of about 70 Atm or higher (typically 70-150 Atm) and will typically be impressed into the nanocarbon sample for a short period of time, such as for example about a few seconds. Alternatively, the gas may be impressed into the nanocarbon sample either in a multiple impression operation or a continuous impression operation. Thus, for example, when impressing hydrogen into a nanocarbon sample according to the invention, the hydrogen is impressed in the nanocarbon multiple times at intervals or continuously until the hydrogen pressure in the nanotube and in the donating hydrogen vessel are equalized.

The invention also seeks to provide a method of impressing a gas such as a noble gas or hydrogen into a nanocarbon sample, which method comprises an initial step of heating the nanocarbon sample, optionally applying a vacuum to the heated sample, and impressing the gas into the sample. Generally, the heating step is carried out before the vacuum step, however, in one embodiment the heating step is carried out in an atmosphere of an inert gas, preferably in helium or argon. Typically the sample is re-heated at an elevated temperature which is preferably greater than 500° C. and more preferably about 535° C., ideally for a short time such as, for example, a few minutes (up to 10 minutes).

The invention also seeks to provide a method of preparing nanocarbon samples for gas impression, which method comprises the general step of oxidising the sample according to the oxidising steps indicated above.

Preferably, the majority of the nanotubes in the nanocarbon sample used in the method of the present invention are less than 1 micron in length, i.e., they are shortened nanotubes as described above. More preferably, the majority of the nanotubes in the nanocarbon sample used in the method of the present invention are between 0.2 and 0.5 microns in length. Typically, the nanocarbon sample comprises carbon nanotubes, including their new modification, namely Single Wall Nano Horns (SWNHs) [19,20]. The SWNHs (nanohorns) are elongated Single Wall globules with conical tips of 20° and diameters of 2-3 nm and lengths of 30-50 nm, thus they are very close to our SWNTs by diameters but much shorter in length. The SWNHs typically form spherical aggregates with diameters of about 80 nm. In our nanocarbon samples the SWNHs' aggregates sometimes exceed 200-300 nm or even bigger. The SWNHs have an open pore structure but mostly their pores are closed (typically in three times greater). Supposedly, the SWNHs are stable during the first and second oxidation steps of the present invention and the closed pores are opened during the third oxidation step. Thus, this step must be controlled very carefully for the samples mostly containing the SWNHs as they are too short to survive in severe conditions for a long time. Thus, for such samples it is preferred to re-heat the samples in an inert gas atmosphere in order to prevent further decomposition of the SWNHs during a multiple usage (a gas recharging) of the nanocarbon absorbent (for example, in a fuel cell).

Preferably, the majority of the shortened single wall nanotubes (sh-SWNTs) in the nanocarbon sample used in the method of the present invention are between 2 and 5 nanometers in diameter.

The nanocarbon sample may be of any size, the present invention is particularly suitable for encapsulating gases in bulk samples. That is samples having more than trace levels of nanotubes/nanohorns/nanofibers (GNFs).

Preferably, said gas is an inert (noble) gas.

Preferably, said inert (noble) gas is helium, argon, krypton, xenon and their radioactive isotopes.

Optionally, the gas is hydrogen.

Preferably, the method of the present invention further comprises displacing a first gas encapsulated in the nanocarbon sample with a second gas by heating the gas containing nanotubes in vacuo and impressing said second gas into the nanotube sample. Preferably, the re-heated nanocarbon sample is purged using a vacuum to remove said first gas.

Preferably, the second gas is impressed into the nanocarbons at a pressure of approximately 70-150 Atmospheres.

The present invention will now be described by way of example only with reference to the accompanying drawings of which:

### BRIEF DESCRIPTION OF DRAWINGS

FIG. 1 is a schematic illustration of a first apparatus (Apparatus-1) for producing fullerenes, carbon nanotubes and nanoparticles according to the present invention;

FIG. 2 is a typical TOF ESI-Mass Spectrum of the eluent before filtration through Molecular Sieves of 8/10 Å. The Mass Spectrum was collected for 1.7 to 5.9 minutes for Sample 1.

FIG. 3 shows typical TOF ESI-Mass Spectra of the eluents after filtration through Molecular Sieves of 8/10 Å. The Mass Spectrum was collected for 0.1 to 40 minutes for Sample 2 and 0.1 to 16 minutes for Sample 3.

FIG. 4 shows TOF ESI-Mass Spectra of the eluents filtered through the Molecular Sieves of 8/10 Å (Sample 3) after keeping them for three and six months;

FIGS. 5a-d are typical TEM image of deposits produced using an AC arc with applied voltage of 53 Volts in Apparatus-1, (a) 3-phase current, benzene/acetone=1:1; (b) 1-phase current, toluene; (c) “curly” nanocarbon, 3-phase current, toluene/Co/Ni-naphterates; (d) 3-phase current rectified with diodes (pulsed positive modes), benzene; and

FIG. 6 shows an experimental dependence of the deposits compositions and their outputs versus a DC voltage applied in Apparatus-1;

FIG. 7 is a typical TEM image of deposits produced in benzene using a DC arc with applied voltage of 24 Volts using Apparatus-1;

FIG. 8 is a typical TEM image of deposits produced in cyclohexane using a DC arc with applied voltage of 24 Volts using Apparatus-1;

FIG. 9 is a Micro-Raman Spectrum of sh-SWNTs. Figures at the peaks indicate the diameter in nm of the sh-SWNTs.

FIG. 10 is a typical TEM image of sh-SWNTs according to the present invention.

FIG. 11 is a typical TEM image of sh-MWNTs according to the present invention.

FIG. 12 shows the electron emission from a sh-MWNT powder sample. D=400 μm, T=140 seconds, 1^{st} scan.

FIG. 13 is a schematic illustration of an apparatus (Apparatus-2) for producing fullerenes carbon nanotubes and nanoparticles according to the present invention;

FIG. 14 shows an experimental dependence of the deposits compositions and their outputs versus a DC voltage applied in the apparatus of FIG. 13;

FIG. 15 is a schematic view of two alternative electrodes of FIG. 13;

FIG. 16 shows typical micro-Raman spectra of carbonaceous samples as produced by Rosseter Holdings and STREM;

FIG. 17 show a typical XRD profile and TEM image of deposits produced as coatings over W anodes at 30V in toluene; and

FIGS. 18a-c show typical TEM images of nanotube deposits produced over Mo anodes at 36V in toluene mixtures; and

FIG. 19 shows a TEM image of deposits produced over a Mo anode at 60V.

FIG. 20 is a scheme of a Gas Storage System realizing the method of the present invention; and

FIG. 21 shows diagrams for hydrogen and argon storage in nanocarbon samples at room temperature and pressure of 70 (H₂) and 110 atm (Ar).

### DETAILED DESCRIPTION OF THE INVENTION

### EXAMPLE 1

### Producing Fullerenes

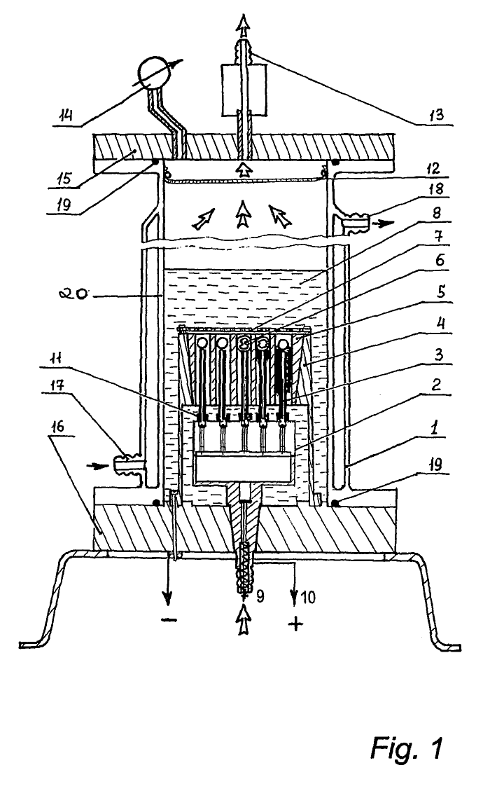

As shown in FIG. 1 individual cell of the apparatus for producing fullerenes includes a hermetically sealed body 1, in which a holder 2 of the electrodes A (3) and a holder 4 of the electrode B (5), and spherical graphite contactors 6 are situated above the electrodes A below a metallic grid 7. This arrangement is immersed in a hydrocarbon liquid 8 and is connected to a valve 9 for flowing a buffer gas, and to a standard AC power supply 10 typically used for welding (three phase voltage, 53V, 50 Hz). Cylindrical graphite pipes 3 (electrodes A) with a smaller diameter are installed in holder 2 by using cylindrical ceramic insulators 11 and are connected to the holder using safety wires. The pipes are axially installed inside a vertical cylindrical opening of a graphite matrix 5 (electrode B).

FIG. 1 shows a design of the apparatus with 19 pairs of the electrodes/contactors vertically aligned in a compact hexagonal package.

Graphite pipes have a length within a range of 20 to 50 mm or longer and external/internal diameters of 4/1-2 mm provide electrode A3. Corresponding, spherical graphite contactors with a diameter within a range of 11-12.5 mm are put above the pipes onto the cylindrical openings of the graphite matrix 5 (electrode B) and the openings have a diameter within a range of 13-13.5 mm. All the graphite parts were made of a Russian commercial graphite, type MPG-6.

A cylindrical stainless steel body (chamber) 20 is filled from the top by an aromatic liquid, like benzene, toluene, xylenes, etc., or their mixtures to a level that is, at least, enough to cover the spherical graphite 6 contactors. Whatman filters 12 are installed at the top of the body to adsorb soot particles going from the liquid with bubbles of released gases.

Before the apparatus is switched on, air is pumped out from the body 1 through the automatic valve 13 and pure argon gas is pumped through the valve 9 to the pipes to fill the empty space to a pressure that is optimal for producing a required higher fullerene. The pressure is controlled by a manometer 14. Top 15 and bottom 16 lids are made of TEFLON® to provide insulation and the possibility of observing arcing during the process. Water cooling the body (and the liquid) is flowing through the inlet 17 to the outlet 18. Rubber rings 19 seal the body.

A buffer gas pressure in the pipe is controlled on a level that is enough to keep a gas bulb at the pipe tip, so that the gas flow through the arc will be initiated by a temperature gradient automatically as soon as the arc starts.

As soon as the power supply 10 is switched on the process starts. With a normal AC regime an arc is generated between the contactor 6 and electrodes 3,5 by turn, therefore, the both electrodes 3,5 and the contactor 6 are slowly eroded and covered with cathode deposits at the same time, maintaining the electrodes geometry practically constant for hours. Using diodes allows feeding the pipes (electrode A) as anode, so just the pipes and contactors are slowly eroded in the process. This measure halves fullerene yields.

The arc is maintained as bright as possible, i.e. an intensity of the arc's electric current is maintained as high as possible by varying such parameters as a pressure inside the body, a liquid's composition (changing dielectric constant), arc's cross section, the type of a graphite used for the electrodes/contactors, etc. We found that at AC voltage of 53 Volts the arc's intensity of 100-300 A/cm² is enough to produce C98 with a high yield in benzene-based liquids. It corresponds to an electric current of 3-12 Amp for the arc's cross section of 3-4 mm² in the above mentioned electrode geometry.

To obtain an optimal regime for the said brightest arc, one can use an oscilloscope to control the dependence of the electric current versus time. Afterwards, an average current is roughly controlled by a proper commercial probe based on the Hall effect.

Thus, while using a bigger processor with about 100 pairs of the electrodes an average current is in the range 100-110 Amps, whereas for a smaller processor with 19 pairs of the said electrodes the average current varies within the range of 15-30 Amps.

The duration of the producing (0.5-8 hours) depends on solubility of a produced fullerene in the treated liquid.

If solubility of the fullerenes is higher than their concentration in the treated liquid, the fullerenes will mostly accumulate in the liquid. For instance, we have found that our apparatus produces C98 in pure benzene with a yield of about 0.4 mg per first 30 min per a pair of the electrodes. The most compact geometry of the apparatus, which allows reduction of the liquid to a reasonable minimum of about 20 ml per pair of electrodes. It seems to be the concentration of C98 of 0.02 mg/ml (after first 30 min), which looks much lower than the solubility for C98 in benzene. For instance, solubility of C60 in benzene is about 1 mg/ml and it is the lowest among aromatic liquids. Therefore, in pure aromatic liquids and their mixtures most of the produced fullerenes will be in the liquid. However, as soon as soot particles appear in the liquid in enough quantities they will adsorb nearly half of the produced fullerenes. Therefore, using pure aromatic liquids requires extraction of the fullerenes from the both fractions, the liquid and soot.

We have successfully produced mixtures of lower and higher fullerenes treating by 120-150 ml of pure benzene (samples 2 and 3) and/or benzene mixed with diesel fuels (samples 1) in an apparatus having one pair of the electrodes for 30 min. Sample 1 was produced without impressing a buffer gas and with an air ambient above the liquid. Sample 2 was produced with impressing argon at flow inlet of about 0.002-0.003 m³/h per cm² of a total cross section of the arcs. Sample 3 was produced with impressing argon at flow inlet of about 0.001 m³/h per cm² of the total arc cross section).

After the treatment all the liquids were filtered through Whatman N42 (about 0.2 g of soot was collected for samples 1 and by about 1 g of soot was collected for samples 2 and 3). The liquids and soot samples were dried in a vacuum oven at 70° C. Then dark brown residues of the benzene liquids (samples 2 and 3) and black soot samples were washed for 2-24 hours with hot methanol and/or acetone using magnetic stirrer and/or a Soxlet extractor.

After the washing the residues (of the liquids and soot samples) were extracted with 100 ml of benzene or chlorobenzene in Soxlet for 6 and 24 hours, correspondingly.

Some of samples were filtered through Molecular Sieves to separate lower fullerenes from higher fullerenes (combination of 8 Å and 10 Å granular sieves by 2-3 grams in a tube with an internal diameter of 11.2 mm). The filtered liquids were concentrated to about 2 ml and about 50 μl of each sample were analyzed by HPLC-MS using an analytical column and Promochem Buckyprep (preparative) column coupled with TOF ESI-Mass Spectrometer VG Bio Lab. Aldrich C₆₀/C₇₀ fullerite and Higher Fullerene reference samples were used to calibrate the HPLC-MS device.

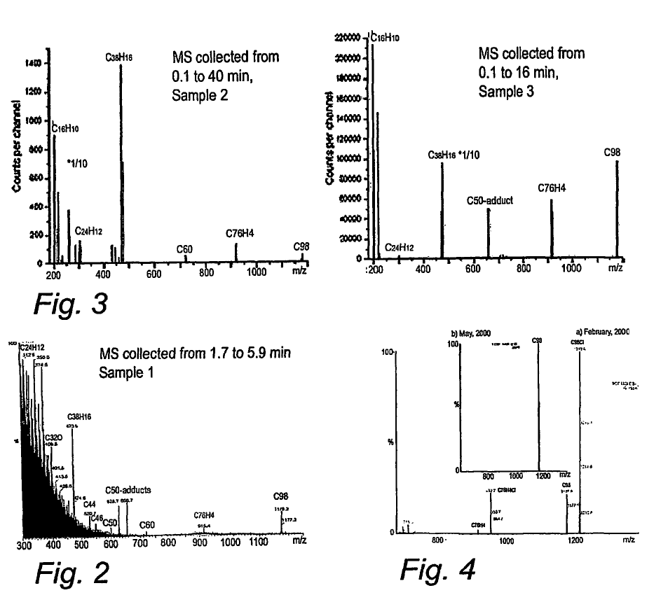

FIG. 2 shows HPLC (analytical column, hexane:toluene=95:5, UV signal for 330 nm), TOF ESI-Mass and UV Spectra of sample 1 that was not filtered through Molecular Sieves. TOF ESI-MS and UV spectra of Aldrich fullerite reference sample had features typical for C₆₀ and C₇₀ only. HPLC diagrams of sample 1 (FIG. 2) demonstrate a presence of numerous peaks, one of them at 3.01 min retention time corresponds to C₆₀. MS spectra show that the analytical column regularly elutes C₉₈, without any characteristic peaks. UV spectra collected for several registered HPLC peaks confirm this behavior of C₉₈. One can see, that among fullerenes higher than C60, C98 is the main species (˜70%) with nearly 20% of C76H4-adduct and about ˜10% of C60.

FIG. 3 shows TOF-Mass Spectra of samples 2 and 3 filtered through Molecular Sieves and kept for about 3 month in glass vials. These spectra were obtained by using the HPLC-MS device equipped with the Buckuprep column. According to the spectra of sample 3, C98 was produced with an estimated output greater than 0.4 mg per 30 min per a pair of the electrodes (the arc's cross section is about 3-4 mm²). Thus, operating with 19-pair-electrodes apparatus allows producing greater than 7.6 mg of C98 per 30 min. Traces of C₁₅₀ were found in sample 3.

A Mass Spectrum in FIG. 2 shows that the main fullerene species are C₅₀ with adducts (we suppose that these are methylene adducts, C₅₀(CH₂)₂ and C₅o(CH₂)₄) and C₉₈, whereas C₆₀ and C₇₆H₄ are in 5 times lower. Species lower than C₅₀ fullerene might belong to lower fullerenes (C₂₈, C₃₀, C₃₂, C₃₈, C₄₄ and C₄₆) as well as to polycyclic aromatic compounds (PAC). MS shows that the main PACs for sample 1 are C₁₆H₁₀, C₂₄H₁₂ and C₃₈H₁₄ which usually are found to be the most stable hydrocarbons in aromatic flames.

FIG. 3 demonstrates that most of lower species, including C₅₀ fullerene and C₅₀(CH₂)₂, were separated from the samples 2 and 3 by using the filtration through Molecular Sieves with pores of 8 and 10 Å. As the Molecular Sieves are not able to separate PACs, one can conclude that the missing species are lower fullerenes and their adducts/compounds, namely C₂₈(336 a.u.), C₂₈CH₂ (350), C₃₀(360), C₃₀CH₂ (374), C₃₂(384), C₃₂O(400), C₃₈(456), C₄₄H₂ (530), C₄₆ (552), C₅₀ (600) and C₅₀(CH₂)₂ (628).

One can discover a correlation between concentration of C₁₆H₁₀, C₂₄H₁₂ and C₃₈H₁₄ (precursors) and C₅₀, C₆₀, C₇₆H₄ and C₉₈ fullerenes. Relying on the correlation discovered, we suggest that all said fullerenes but C₉₈ are produced (under conditions of the described experiment) due to plasma-chemical interactions between two of these most stable polycyclic precursors, namely C₁₆H₁₀, C₂₄H₁₂ and C₃₈H₁₄, as following:

C₁₆H₁₀+C₁₆H₁₀ 1.

→C₂₈+2C₂+5H₂

→C₃₀+C₂+5H₂

→C₃₂H₂+4H₂

C₁₆H₁₀+C₂₄H₁₂ 2.

→C₃₈+C₂+11H₂(C₃₈ disappeared when C₂₄H₁₂ was strongly reduced)

C₂₄H₁₂+C₂₄H₁₂ 3.

→C₄₄+2C₂+12H₂(C₄₄ disappeared when C₂₄H₁₂ was reduced)

→C₄₆+C₂+12H₂(C₄₆ disappeared when C₂₄H₁₂ was reduced)

C₃₈H₁₆+C₁₆H₁₀ 4.

→C₅₀+2C₂+13H₂

→C₅₀(CH₂)₂+C₂+11H₂

→C₅₀(CH₂)4+9H₂

C₃₈H₁₆+C₂₄H₁₂ 5.

→C₆₀+C₂+14H₂(C₆₀ disappeared when C₂₄H₁₂ was reduced)

C₃₈H₁₆+C₃₈H₁₆ 6.

→C₇₆H₄+14H₂ (it was always present and so was C₃₈H₁₆)

Whereas, C₉₈ and, probably, C₁₅₀ are supposedly produced by plasma-chemical interactions between two of C₅₀ (or C₅₀-adducts) and C₇₆H₄ as following:

C₅₀+C₅₀

→C₉₈+C₂

C₅₀+C₅₀(CH₂)₂

→C₉₈+C₂+2CH₂

C₅₀+C₅₀(CH₂)₄

→C₉₈+C₂+4CH₂

C₅₀(CH₂)₂+C₅₀(CH₂)₄

→C₉₈+C₂+6CH₂

C₅₀(CH₂)₄+C₅₀(CH₂)₄

→C₉₈+C₂+8CH₂

C₇₆H₄+C₇₆H₄

→C₁₅₀+C₂+4H₂

Using different regimes (for instance, with DC of 24 Volts) we found wider distributions of produced higher fullerenes, including C₈₄, with a presence of C₅₀, C₆₀, C₇₆ and C₉₈ as well.

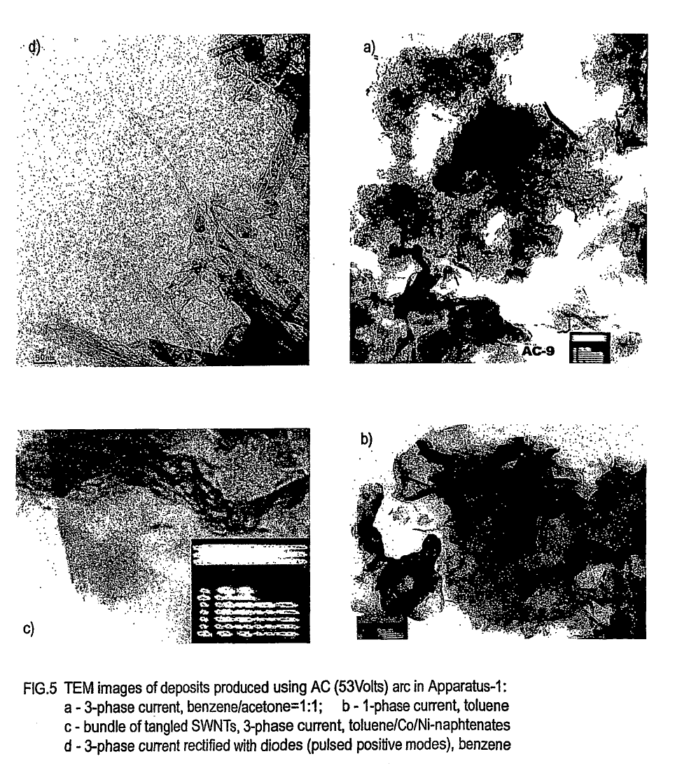

C₉₈ appears to be the most stable fullerene species among those present in sample 3. We repeated MS tests for the sample after keeping it for about 3 months in the testing vials. Residues were dissolved with toluene and injected in the TOF Mass Spectrometer directly. FIG. 4 shows mass spectra of the filtered eluents (samples 3) after keeping them for about three months after filtering through Molecular Sieves (FIG. 4a) and then after keeping them in the testing plastic vials for an additional 3 months (FIG. 4b). Mass Spectra revealed mainly C₉₈ and traces of C₁₅₀ (FIG. 4b), whereas PAC C₃₄H₁₆ was at nearly the same level as it was before. Notice that residues of samples 3 diluted with toluene demonstrate no “chlorinated” species.

Using our process and apparatus it is possible to produce a desirable fullerene preferentially, i.e. with few admixtures of other fullerenes and without using HPLC preparations. For instance, C₉₈ has been already produced at mg-scales. Changing regimes of the arc allows variation in the composition of the PAC precursors and, finally, varying the composition of higher fullerenes produced.

One can understand that C50 and other lower fullerene species adsorbed by the Molecular Sieves could be extracted from them by a certain elution. Thus we might have additional by-products, C50, C46, C44, C38, C32, C30, C28, etc.

### EXAMPLE 2

### Producing Nanotube/Nanoparticle Deposits with an AC Power Supply Using the Apparatus of FIG. 1.

Apparatus 1 can be used (FIG. 1) to produce nanotube deposits over the electrodes 3,5.

The body is filled by an aromatic liquid 8, like benzene, toluene, xylenes, Co- and Ni-naphtenates based on toluene etc., or their mixtures to a level that is, at least, enough to cover the contactors 6.

Before the reaction commences, air is pumped out from the body through the outlet of a safety valve 13 and pure argon gas is pumped through the inlet 9 and through the pipes 3 (electrode A) to fill the empty space to a pressure that is optimal for producing carbon nanotubes/nanoparticles, most preferably, in the range of 600-800 Torr. Afterwards, an argon flow through the opening is maintained in the range of 1-3 liter per hour per a pair of electrodes, i.e. about 20-60 liters per hour for this apparatus.

As soon as the power supply 10 is switched on the process starts. With a normal AC regime an arc is generated between the contactor 6 and electrodes 3,5 by turn, therefore, the both electrodes 3,5 and the contactor 6 are slowly eroded and covered with the deposits at the same time.

Argon flow in the pipe/opening provides the optimum conditions under which formation of nanotube/nanoparticle deposits starts.

The production of nanotube deposits starts at first turn in the opening in which argon flow is higher. In this case, electrodes A3 are made as rods without openings. All electrodes A3 are connected to the electrode of a power supply 10 by means of a safety wire that melts when a process of formation of a nanotube/nanoparticle deposit around a certain electrode is finished.

One can understand that the apparatus is able to produce the deposits even if electrodes A3 are placed inside the matrix's openings horizontally.

All 19 electrode pairs used in this example are simultaneously fed by the power supply. The arcing between different pairs is self-arranged in line. An electric current through a certain arc gap increases while a deposit grows downward. While an edge of the deposit achieves a bottom of the opening the current increases up to 30 Amps. At this point, and the safety wire is melted and deposition stops. As soon as the process is finished in one opening the next pair of electrodes, where the argon flow is optimal, start producing a deposit.

An AC voltage of 53V produces about 1 gram of carbonaceous deposit per 1 min per a pair of electrodes. In nearly 20 min the apparatus with 19 pairs of electrodes produces about 20 grams of the deposit.

According to Transmission Electron Microscope (TEM) pictures (see FIG. 5a-c), nanotubes appear as MWNTs with diameters within the range from 2 to 20 nm, whereas buckyonions appear with sizes within the range of 4-70 nm. According to X-Ray Diffraction (XRD) profiles, these deposits mainly consist of graphitic carbon (from 40 to 90 wt %) rather than MWNTs/nanoparticles (total sum is within the range 1-10 wt %). “Curly” nanocarbons are presented in the deposits (see at FIG. 5c).

Using diodes allows feeding the pipes (electrodes A) as anodes, so just the pipes and contactors are slowly eroded in the process. FIG. 5d shows a typical TEM image of deposits produced with 3-phase current rectified with diodes to a pulsed positive (at electrodes A3) mode current.

Using lower voltages looks more preferable as it allows producing the deposits with higher concentration of nanotubes.

However, producing nanotubes and nanoparticles is more preferable with using a DC power supply.

### EXAMPLE 3

### Producing Nanotube/Nanoparticle Deposits with a DC Power Supply Using the Apparatus of FIG. 1.

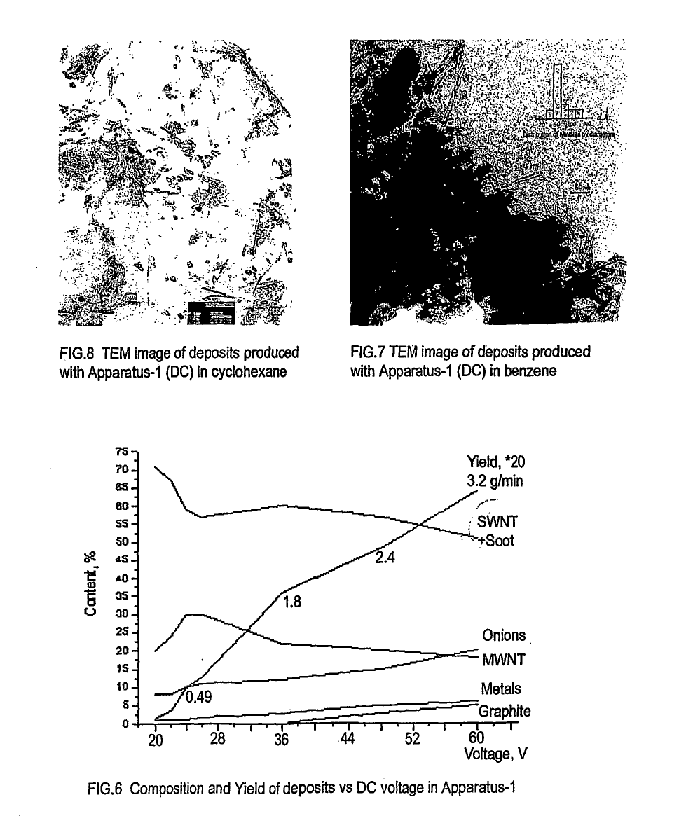

DC power supplies appear to be more preferable for producing nanotube/buckyonion deposits. FIG. 6 shows an experimental dependence of the deposits compositions and their yields versus a DC voltage applied. From this dependence one can see that in this apparatus producing nanotube/nanoparticle deposits starts at voltage of about 20 V.

The most preferable voltage for producing MWNTs is within the range from 24 to 30V with the deposits' yields of 0.4-1.0 g/min, correspondingly. Increasing applied voltages over 36V are likely to increase yields of buckyonions, graphite and metal clusters.

Increasing the applied voltage over 28-30 Volts requires putting one or two additional contactors above the usual one to maintain optimal arcing (these additional contactors are not eroded at all and may be used many times).

There are two different kinds of deposits, “hard” shells and “soft” deposits, in this geometry of the apparatus.

Surprisingly, the shells are formed around the contactors when the contactors work as anodes and, therefore, the contactors are eroded during the production. In TEM pictures deposits appear as plenty of MWNTs with a rather narrow diameter distribution about 6 nm±1 nm with about 6±1 layers (see FIG. 7).

With a DC regime cathode (the matrix) is not eroded, whereas the contactors are eroded in a high extent and the anodes (pipes or rods) 3,5 are eroded slowly.

For an applied voltage of 24V TEM, XRD and Raman spectrometry show a composition of the shells as following: MWNTs=5-30 wt %, nanoparticles=5-10 wt %, amorphous carbon and “curly” carbon=50 wt %, graphite=50-10 wt %, metals≦1-2 wt %.

The “soft” deposits are formed around the electrodes A (anodes) in case the pipes are eroded instead of the contactors. These “soft” deposits are characterized by nearly the same content of MWNTs and nanoparticles.

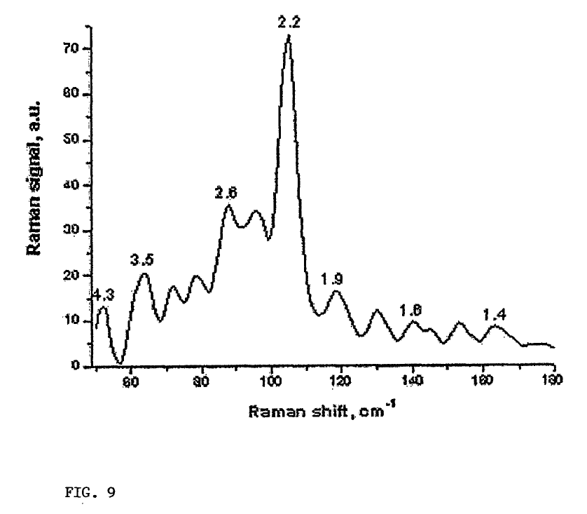

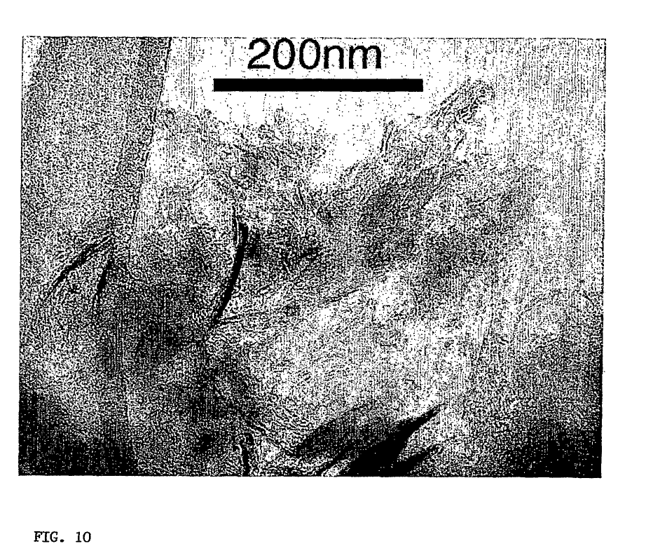

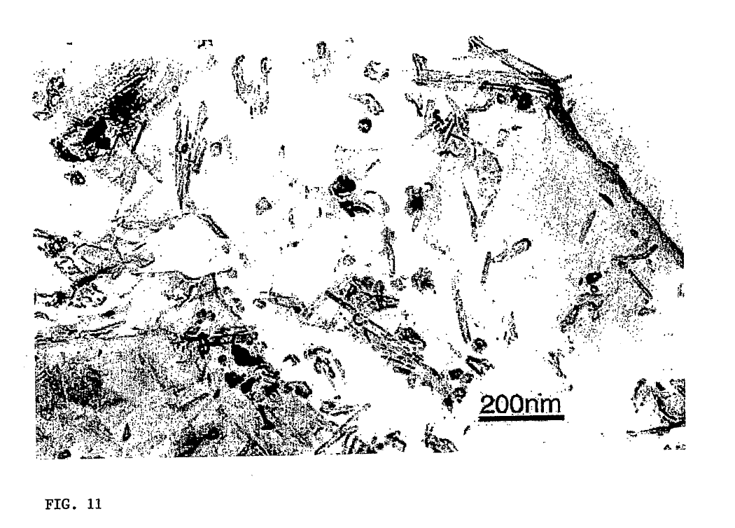

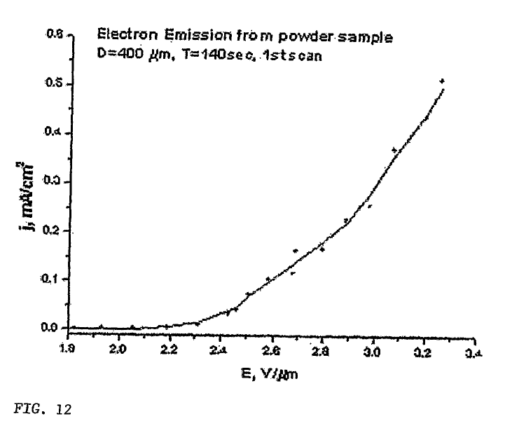

Using mixtures based on cyclohexane, the apparatus produces the deposits in 3 times less but with higher contents of MWNTs and nanoparticles, than using aromatic mixtures. FIG. 8 shows a typical TEM image of deposits produced using Apparatus-1 in cyclohexane. One can see that MWNTs are mainly short, some of them are bent but practically all of them have nearly the same diameter.

Diluting aromatics with hydrocarbon liquids, like acetone, allows increasing relative outputs of MWNTs/buckyonions up to 70% wt. Using different material for electrode B (cathode) does not influence the output of the deposits. However, using a stainless steel (SS) matrix leads to the production of only “soft” deposits enriched by MWNTs and slightly depleted by SWNTs. Besides, only anodes (electrodes A) are eroded with a stainless steel matrix, i.e. arcing is situated just between the anodes (pipes/rods) and contactors.

Using a brass matrix leads to a slight reduction of MWNTs/nanoparticles and an increase of “curly” nanocarbons. With a brass matrix both the anodes and contactors are eroded.

Raman spectrometry, XRD and TEM show that impregnating electrodes A (pipes) and C (contactors) with Co and Ni oxides leads to an increase of “curly” nanocarbons, mostly composed of graphite nanofibers (GNFs), up to 40% wt., whereas total yields of the deposits are nearly the same as without Co and Ni catalyzers.

Adding soluble organometallic compounds to the liquids, like Fe-, Co- and Ni-naphtenates in toluene solutions, allows increasing yields of GNFs due to the simultaneous production of Fe, Co and Ni nanoclusters which catalyze GNFs' growth.

Dissolving sulfur or sulfur compounds in the liquids promotes GNFs' growth further. Where using elemental sulfur dissolved in toluene up to concentration of 2-7 wt % is used, a new form of GNF deposit appears, very thin “cloths” or “rags” are deposited on walls of the body. We preliminary found that such deposits were mainly composed of GNFs (up to 40-50 wt %), amorphous carbon (10-30 wt %), carbon and metallic nanoparticles (50-20 wt %).

Increasing the distance between the anode base (holder) and the matrix (cathode) allows growth of deposits outside the cathode matrix's openings. The deposits grow side-ward and downward (toward the anode base) over the anodes due to arcing between an edge of the deposits (cathodes) and side surface of the anodes, like the “soft” deposits grow, but cross sections of the deposits are in 2 times greater than that of deposits grown inside the openings. We found that composition of said “outside” deposits is nearly the same as composition of deposits grown inside the cathode openings and nanotubes' yields are essentially higher (in 1.3-1.6 times) than with growing inside the openings. The deposit growth continues until all the anode is covered with the deposit.

This fact opens a lot of opportunities for continuous growth of nanotube deposits. We found, that the cathode (matrix) is required just to start the arcing (to create deposits) and afterwards the arcing goes between anodes and deposits (cathode), therefore, elongating anodes is enough for providing a continuous production of nanotube/nanoparticle deposits whereas the cathode matrix might be made as “short” as possible.

Elongated metallic rods or pipes might be very useful to provide such processes in Apparatus-1. We found that stainless steel rods/pipes are not very suitable anodes because of their low melting points, whereas tungsten and molybdenum anodes are good enough to replace graphite electrodes.

We use the same apparatus (Apparatus 1) as described above with 6-7 anodes simultaneously fed by the DC power supply. The arcing between different pairs is self-arranged in line. An electric current through a certain arc gap increases while a deposit grows over the anode (electrode A) downward from the matrix's opening (soft) or around the spherical contactor (shells). When either an edge of the deposit reaches a bottom of the opening or a surface of said shells closely contacts a surface of the matrix's opening (cathode), the current increases up to 30 Amps and the safety wire is melted and production of the deposit is stopped. As soon as the process is finished in one opening the next pair of electrodes, where the argon flow is optimal, starts producing a deposit.

Arranging feeding by 7 anodes (electrodes A) simultaneously allows constructing apparatuses as big as possible, for instant with several hundreds of said electrode pairs.

With our apparatus of 19 anodes we produce about 10 grams of the deposit per 20 min of operation, applying a DC arc voltage of about 24 Volts. TEM picture (FIG. 7) shows a high quality of the deposit as produced. TEM, XRD and Raman spectrometry show a composition of the deposit as following: MWNTs=30%, nanoparticles=10%, amorphous and “curly” carbon=32%, SWNTs=25%, metals=0-3%.

In the present invention, proper cracking of the hydrocarbon liquids driven by an optimal energy input provides the lowest specific energy consumption for producing fullerenes, nanoparticles and nanotubes.

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

Our invention allows a continuous production of nanotube deposits with record yields of 0.2-1 g/min per a pair of the electrodes with a very low specific consumption of electric energy of 50-100 kW*hour per 1 kg of the deposit produced. Using processors with several electrodes pair and elongated anodes allows to produce nanotubes and nanoparticles in bulk.

### EXAMPLE 4

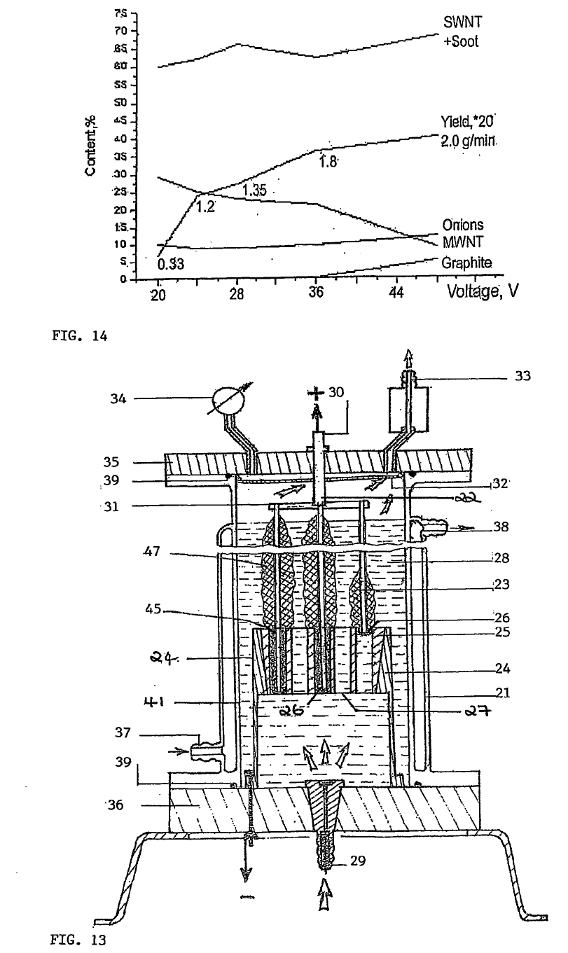

### Producing Nanotube/Nanoparticle Deposits Using the Apparatus of FIG. 13

The apparatus for producing fullerenes illustrated in FIG. 13 includes a hermetically sealed chamber 21, in which a holder 22 of the electrodes A 23 and a holder 24 of the electrode B 25, and fixed spherical or hemisherical graphite contactors 26 are situated below the electrodes A 23 above a metallic grid 27. This arrangement is immersed in a hydrocarbon liquid 28 and is connected to a valve 29 (for adding a buffer gas into the chamber 1 around the electrodes), and to a standard AC power supply 30 typically used for welding (three phase voltage, 53V, 50 Hz).

Cylindrical rods 23 (electrodes A) with a smaller diameter are installed in holder 22 by using cylindrical ceramic insulators 31 and are connected to the holder using safety wires. The rods 23 are axially installed inside a vertical cylindrical opening of a graphite matrix 25 (electrode B).

FIG. 13 shows a design of the apparatus with 19 pairs of the electrodes/contactors vertically aligned in a compact hexagonal package. Graphite rods have a length within a range of 20 to 50 mm or longer and external/internal diameters of 4/1-2 mm provide electrode A 23. The graphite contactor is made of a Russian commercial graphite, type MPG-6.

### EXAMPLE 5

### Producing Sh-NT and Nanoparticle Deposits with a DC Power Supply Using the Apparatus of FIG. 13.

In use, the cylindrical stainless steel body 41 of the chamber 21 is filled from the top by a hydrocarbon liquid, like benzene, toluene, acetone, cyclohexane, paraldehyde etc., or their mixtures to a level that is, at least, enough to cover the spherical or hemisherical graphite contactors 26. Whatman filters 32 are installed at the top of the body to adsorb soot particles going from the liquid with bubbles of released gases.

Before the apparatus is switched on, air is pumped out from the body 21 through the automatic valve 33 and pure argon gas is pumped through the valve 29 to the pipes to fill the empty space to a pressure that is optimal for producing nanotubes. The pressure is controlled by a manometer 34. Top 35 and bottom 36 lids are made of TEFLON® to provide insulation and the possibility of observing arcing during the process. Water cooling the body (and the liquid) is flowing through the inlet 37 to the outlet 38. Rubber rings 39 seal the body.

Buffer gas pressure in the pipe is controlled on a level that is enough to keep a gas bulb at the pipe tip, so that the gas flow through the arc will be initiated by a temperature gradient automatically as soon as the arc starts.

In a preferred embodiment, Mo or W anodes (with diameters of about 3-4 mm) are hung up inside the matrix's opening from the top lid of the body. Graphite (made as spheres and/or halves of spheres, and/or prisms with triangle or square cross sections, cylinders or truncated cylinders, flat plates etc.) or metallic (for instant, made in a rectangular shape of Ti-sponge or Al cylinders) contactors 26 are attached to the free endings of the anodes closely to a surface of the matrix openings (cathode).

Such geometry provides two opportunities for producing nanotube deposits. The first one is producing inside the openings when growth of the deposits covers over the anodes 23 from below to the top of the opening (see FIG. 13). The second opportunity is growing outside the openings over the anodes 23. In this case the deposit can grow in two directions: both side-wards and upwards (see FIG. 13), thus, deposits are formed with bigger cross sections and lengths limited only by lengths of the anodes 23.

Both opportunities are realized when free anode 23 endings are placed inside the matrix's openings. If the endings are placed close to the top of the openings just a few of said inside deposit 45 will be produced (see FIG. 13). Said inside 45 and outside 47 deposits can be easily separated from each other. We found that said “inside” producing in benzene or toluene (as well as in any other suitable aromatic liquid) starts at a voltage of about 18 or 19 V. The best voltage for producing sh-MWNTs is within the range 24-36 V with deposit yields of 1.2-1.8 g/min, correspondingly (see FIG. 14).

One can see that increasing voltage higher than 36V reduces sh-MWNT yields dramatically. We found just traces of sh-MWNTs with voltage of 60V, whereas the most material in TEM pictures appeared as buckyonions, soot and graphite particles and “curly” nanotubes.

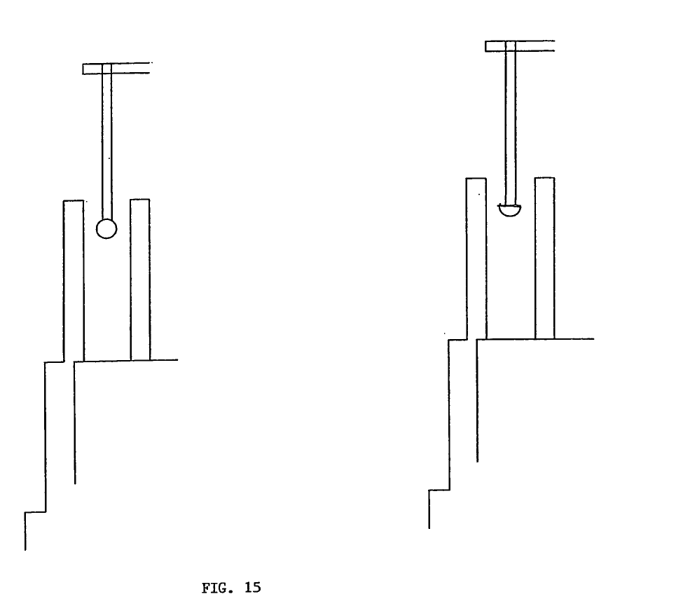

We used one anode to grow nanotube/nanoparticle deposit with the Apparatus-2 of FIG. 13. Inside 45 and outside 47 deposits were produced in toluene/acetone mixture using one W anode (of 3 mm in diameter). A half of a graphite spherical contactor (diameter of about 12 mm) impregnated with Co and Ni oxides (by 3% wt. by the metals) was attached to a free ending of the anode rod and placed in a top of a graphite matrix's opening (cathode) to start arcing at an applied DC voltage of 30 Volts. At the beginning of the arcing an electric current was about 40 to 60 Amps (producing an “inside” deposit with a yield of about 0.7 g/min) then it was in the range from 20-50 Amps producing an “outside” deposit (with nearly the same yield of 0.5 g/min). Both deposits were easily detached from the electrodes and from each other. After the process the W rod was slightly eroded at the free end. The inside 45 and outside 47 deposits (as produced) contains sh-MWNTs=20-40 wt %, polyhedral particle, graphite “curly” and amorphous nanocarbons and metals (0.5-5 wt %). FIG. 15 shows XRD profiles of said “inside” deposit and MWNT-deposit as produced by STREM (shells).

An outside deposit 47 of 30 grams per 12 min (with a yield of 2.5 g/min) was produced with Mo anode (2 rods with diameters of 2.5 mm and lengths of about 10 cm) submerged in a mixture of toluene with Co- and Ni-naphtenates (on a basis of toluene). Co and Ni elemental concentration in said mixture was by about 3% wt. A half of a graphite spherical contactor (diameter of about 12 mm) impregnated with Co and Ni oxides (by 3% wt. by the metals) was attached to free endings of the rods and placed in a top of a graphite matrix's opening (cathode) to start arcing at an applied DC voltage of 36 Volts. At the beginning of the arcing an electric current was in the range 20-30 Amps (producing a small “inside” deposit) then it was varied in the range from 6 to 60 Amps (mean current about of 25 Amps) producing a huge outside deposit 47. Both Mo rods were completely eroded and/or melted during the arcing between the rods and the deposit.

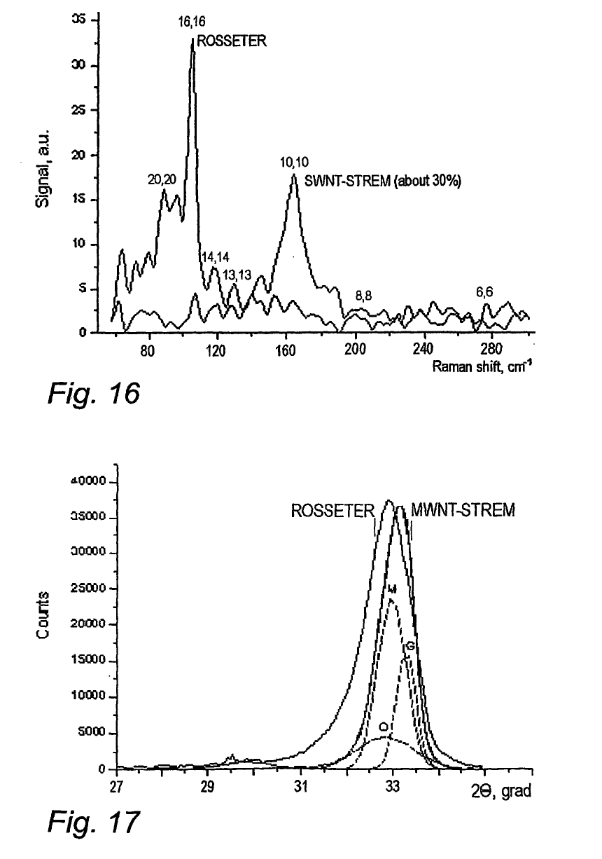

FIG. 16 shows Raman spectra of the deposit and of SWNT (STREM) sample, both as produced.

One can see that all features, Raman peaks corresponding to certain arm-chair SWNTs, are the same in both spectra but our deposit contains SWNTs of bigger diameters, mainly of 2.2 and 2.7 nm that corresponds to armchair SWNTs (16,16) and (20,20), correspondingly, whereas STREM-SWNT mostly consists of (1 1,11), (10,10) and (9,9) armchair SWNTs with few of (16,16) and (20,20) and higher.

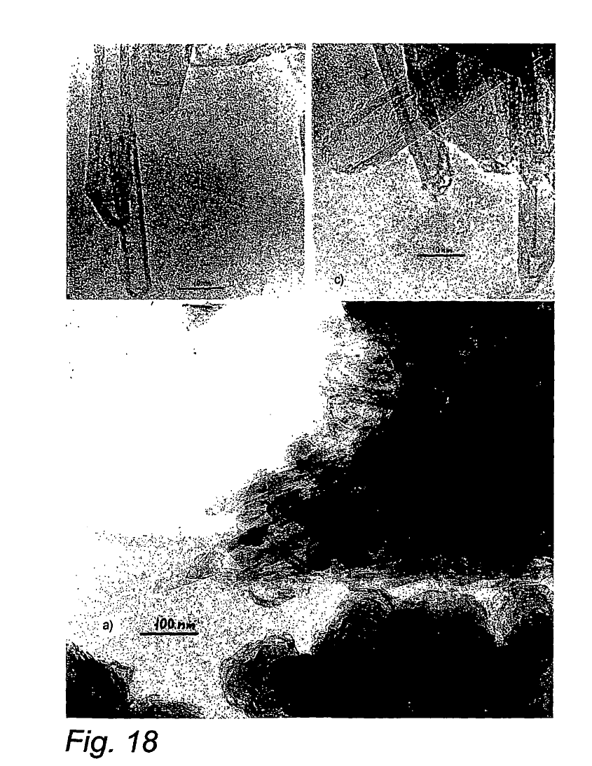

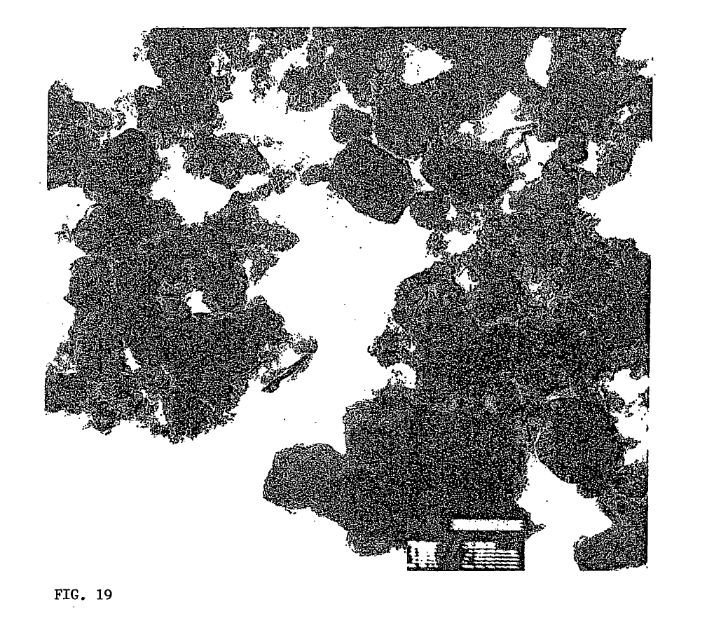

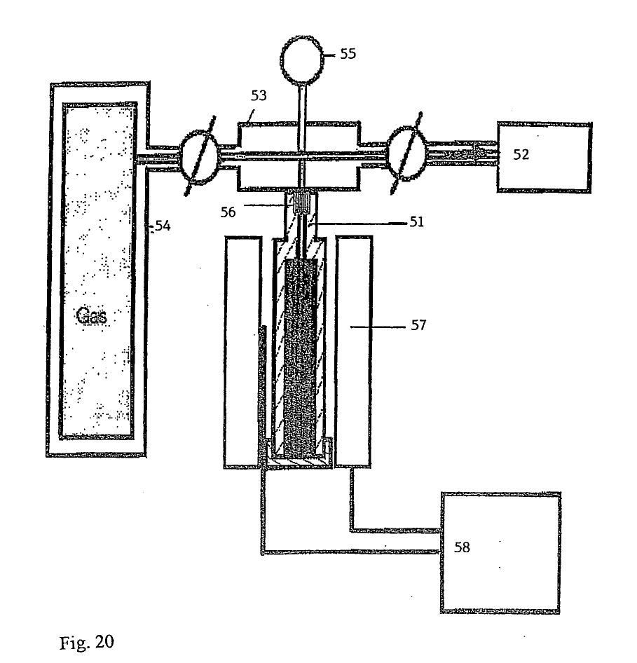

TEM pictures (see FIG. 18a-c) of the deposit confirm these findings. FIG. 18a shows sh-MWNTs and “curly” nanocarbons over all the area shown. A more detailed look at the SWNTs' clusters reveals sh-SWNTs' lengths and diameters within the range 0.1-1 μm and 2-5 nm, correspondingly.

A High-Resolution TEM picture (FIG. 18b) shows that sh-MWNTs have one semispherical and one conical end. Oxidizing in air at temperatures up to 600° C. for 1-1.5 hours allows opening all spherical ends of MWNTs independently from number of the MWNTs' layers and leaving the conical ends to be intact (see FIG. 18c).

We also found that producing deposits over graphite contactors, containing mainly nanoparticles and “curly” nanocarbons was possible with the apparatus of the present invention at applied voltages of 60V or a bit higher. FIG. 8 shows a typical TEM image of deposits produced over Mo anodes at 60V in toluene.

### EXAMPLE 6

### Production of Shortened Nanotubes

To produce the sh-MWNTs and sh-SWNTs as described above, the apparatus of FIG. 13 (Apparatus-2) and the method of described in Examples 4 and 5 was employed using a tungsten 3 mm diameter rod and cyclohexane/acetone/toluene (for sh-MWNTs) and toluene/Co/Ni-naphtenates (for sh-SWNTs) mixtures as the hydrocarbon liquids. A DC voltage of 24 Volts (3 pairs of normal car batteries connected in parallel) was applied to provide an arc current of 20-40 Amps. A narrow sh-MWNT deposit (of about 80 g) was grown over a 40 cm-length W rod for about 4 hours. TEM tests shown that said deposit contained about 20-40% wt. the sh-MWNTs. A 15 gram-deposit produced with Co/Ni-catalysts for about 10 min mostly contained “curly” nanocarbon forms including shorten GNFs (lengths were less than 1 micron), the sh-MWNTs (1-5%) and the sh-SWNTs (of about 1%).

### EXAMPLE 7

### Gas Storage

A nanocarbon deposit of 30 grams was produced using the method of Example 5 in 12 min (with a yield of 2.5 g/min) with using a Molybdenum (Mo) (2 rods with diameters of 2.5 mm and lengths of about 10 cm) submerged in a mixture of toluene with Co— and Ni-naphtenates (on a basis of toluene). Co and Ni elemental concentration in said mixture was by about 3% wt. A half of graphite spherical contactor (diameter of about 12 mm) impregnated with Co and Ni oxides (by 3% wt by the metals) was attached to free endings of the rods and placed in a top of a graphite matrix's opening (cathode) to start arcing at an applied DC voltage of 36 volts.

TEM, XRD and micro-Raman spectrometry show the composition of the deposit (as produced) to be as follows: sh-MWNTs (shortened multiple wall nanotubes) about 30 wt %, total “curly” nanocarbons about 50 wt %, the remainder are carbon and metallic nanoparticles.

FIGS. 18a-18c represent TEM images of the deposit which are composed mainly of a “curly” material (supposedly sh-GNFs, sh-SWNTs and SWNHs) and sh-MWNTs. Lengths of shortened nanocarbons in the deposits are not in excess of 1 micron, and are typically within the range 0.2-0.5 microns.

Therefore, there is no need to cut nanotubes into shorter fragments. It is only required to purify and open them only.

FIG. 16 shows Raman spectra of the deposit and of SWNT (STREM company) sample, both as produced. One can see that all features, Raman peaks corresponding to certain arm-chair SWNTs are the same in both spectra but our deposit contains SWNTs of bigger diameters, mainly of 2.2 and 2.7 nm that corresponds to armchair SWNTs and (20, 20) correspondingly, whereas STREM-SWNT mostly consists of (11,11) (10,10) and (9,9) armchair SWNTs with few of (16,16) and (20,20) and higher. Thus, in average our SWNTs are slightly bigger in diameter that those of Lie et al. (up to 1.8 nm) [18].

The deposit was treated at room temperature with mixtures of nitric and fluoric acids for 16-21 hours (to remove metals without any oxidation of nanotubes), then cleaned with distilled water, dried and oxidised in air at 535° C. for 1 hour. After treatment the deposit was reduced to 25 grams (83% of initial weight) and its composition revealed from XRD and Raman data was as following: shortened Multi-Wall Nanotubes (sh-MWNTs) about 35 wt %, and total of sh-GNFs, sh-SWNTs and SWNHs about 55-60 wt %. This shows that producing nanotubes with a total of 90-95% (or even higher) and a yield of 2 g/min is possible using our method. The percentages of sh-GNFs, sh-SWNTs and SWNHs in our samples were very close to those of Liu et al. for SWNTs (50-60 wt %) [18].

High Resolution TEM picture (FIG. 18b) shows that both, spherical and conical ends of MWNTs (including one Triple Wall Nano Tube) stayed intact after such oxidative treatment, whereas further oxidation in air at temperatures up to 600° C. for 1-1.5 hours opened all of the spherical ends of the MWNTs independently from number of the MWNTs layers and left the conical ends intact (see FIG. 18c). This is highly significant for the survival of very short SWNHs having conical tips and for opening SWNTs which have spherical caps.

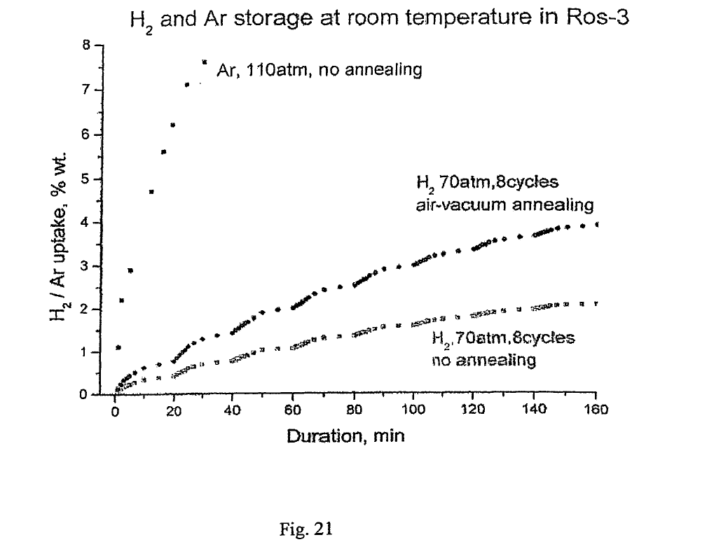

About 10 grams of such a sample was re-heated in air at 535° C. for about 3 minutes and then this hot sample was immediately put in a cylindrical stainless steel cell (of about 12 ml capacity) that was immediately connected to a storage system (see FIG. 21) and vacuum pump 2 was switched on to purge the sample.

A vacuum (oil-free) pump was withdrawn after pumping for about 10-15 minutes and then Argon was shortly (1-2 sec) impressed into the cell through a Gas line 53 from a Gas Container 54 at initial pressure of about 110 atm that was controlled with a normal Pressure Manometer 55. A stainless steel “cotton” filter 56 was used to prevent losses of the samples. A total capacity of the storage system was estimated to be about 20 ml (without a nanotube sample). By immersing samples in acetone, we estimated that “solid” part of 10 grams of the nanotube samples took about 5 ml i.e. a total capacity of a gas system (including inside nanotubes cavities) was about 15 ml. This figure allowed estimating a Gas uptake on a basis of pressure changes. The Gas Storage System was leak-free.

FIG. 22 shows Argon storage for the first 30 min. One can see that Argon storage of about 7.6 wt % was achieved even without annealing of the sample.

We stored Hydrogen gas in the same sample after re-heating it in a vacuum oven at 150° C. for 2 hours. An initial pressure of H₂ was about 70 atm. As the initial pressure was lower, we impressed Hydrogen 8 times repeatedly in each 20 minutes (as soon as the pressure in the gas system dropped for 25-13 atm and Hydrogen storage was practically stopped). This allowed us “pumping” the nanocarbon sample with hydrogen up to 2 wt % after 8 cycles (160 min) without annealing the sample (sec FIG. 22). One can see that this result was very close to the result by Liu [18] for a run without a vacuum annealing. Weighing the sample after withdrawal of the pressure shown that about 40 mg 0.4 wt %. i.e., about ⅕ of a total hydrogen stored) of hydrogen was left in the sample.

Another 10 grams-sample was put in the cell and re-heated in ambient (air) atmosphere at 500° C.-535° C. for about 3 minutes using a heater 57 with thermo-controlling device 58. Then a vacuum was created and maintained in the cell and while the heater was withdrawn letting the sample cool to room temperature. Afterwards, hydrogen was repeatedly (8 times in each 20 minutes) impressed in the cell at 70 atm. After 160 min (8 cycles) Hydrogen uptake of 3.9 wt % was achieved (see FIG. 22) that was even slightly higher that Liu's hydrogen uptake after the same time (for a run with vacuum annealing). Weight the sample after a withdrawal of the pressure shown that about 90 mg (0.9 wt %, i.e., about 23 rel % of a total hydrogen stored of hydrogen was left in the sample. This hydrogen was released under re-heating the sample in a vacuum oven at 150° C. for about 2 hours.

Thus, at an initial pressure of 70 atm about 4 wt % might be stored in 10 grams of about 50-60 wt % of sh-GNFs, sh-SWNTs and SWNHs with a destiny of 37.5 kg H₂/m³.

Improvements and modifications may be incorporated herein without deviating from the scope of the invention.

References:

1. R. E. Smalley. From Balls to Tubes to Ropes: New Materials from Carbon—in Proc. of American Institute of Chemical Engineers, South Texas Section, January Meeting in Houston —Jan. 4, 1996

2. P. M. Ajayan, et al, Nature, 1993, V.362, p.522

3. U.S. Pat. No. 5,641,466, Jun. 24, 1997. Method of purifying carbon nanotubes, T. Ebessen, P. M. Ajayan, H. Hiura

4. U.S. Pat. No. 5,698,175, Dec. 16, 1997. Process for purifying, uncapping and chemically modifying carbon nanotubes. H. Hiura and T. Ebessen

5. T. Ebessen, et al Nature, 358, 220(1992)

6. K. S. Khemani, et al, J. Org. Chem., 1992, V.57, p.3254

7. W. Kraechmer et al, Nature, 1990, V.347, p.354

8. F. Diederich, et al, Science, 1991, V.252, p.548

9. T. Guo, et al, Chem. Phys. Lett., 1995, V.243, p.49

10. D. K. Modak et al. Indian J. Phys., 1993, V.A67, p.307

11. U.S. Pat. No. 5,482,601, Jan. 9, 1996. Method and device for the production of carbon nanotubes, S. Oshima, et al

12. U.S. Pat. No. 5,5,753,088, May 19, 1998. Method for making carbon nanotubes. C. H. Olk

13. U.S. Pat. No. 5,916,642, Jun. 29,1999, R. P. H. Chang

14. Z. Shi, et al. Mass production of SWNT by arc discharge method. Carbon, V.37, N9, pp. 1449-1453, 1999

15. S. Iijima, Helical Microtubules of graphitic carbon. Nature V. 345, p56-58, 1991

16. Andreas Thess et al, Science, 273. 483-487(Jul. 26, 1996)

17. A. C. Dillon, et al. Carbon Nanotube Materials for hydrogen storage. Proceedings of the 2000 DOE/NREL Hydrogen Program Review NREL/CP-570-28890. May 8-10, 2000

18. Liu, et al, “Hydrogen Storage in Single Walled Carbon Nanotubes at Room Temperature”, Science, Vol. 286, page 1127, 1999.

19. K. Murata, et al, Chemical Physics Letters 331 (2000) pages 14-20.

20. J. A. Nisha et al, Chemical Physics Letters 328 pages 381-386.

1. A method for producing fullerenes, nanotubes or nanoparticles, said method comprising:
a) providing a hydrocarbon liquid as an effective carbon source; and
b) providing energy input, such that said hydrocarbon liquid produces acetylene, ethylene, methane or carbon monoxide.

2. The method as claimed in claim 1, wherein said hydrocarbon liquid comprises an aromatic hydrocarbon liquid.

3. The method as claimed in claim 2, wherein said hydrocarbon liquid comprises benzene, toluene, xylene.

4. The method as claimed in any one of claim 1, wherein said energy input is electricity, resistive heating, a laser or electron beam.

5. The method as claimed in claim 4, wherein said energy input is electricity and is provided at a voltage of 18 to 65V.

6. The method as claimed in claim 5, wherein said electricity is provided at a voltage of 24 to 36V.

7. The method as claimed in any of claim 4, wherein an electric arc across two electrodes is created as said energy input.

8. The method as claimed claim 7, wherein said electrodes are formed of graphite, tungsten or molybdeneum.

9. The method as claimed in claim 1, wherein a buffer gas is also provided.

10. The method as claimed in claim 9, wherein said buffer gas is argon.

11. The method as claimed in claim 9, wherein said buffer is present at a pressure of between 0.8 and 1.0 atmospheres.

12. The method as claimed in claim 1, wherein after step b) nanotubes and nanoparticles are separated by mechanical removal of carbonaceous deposits on said electrodes, followed by oxidation, treatment with acids and decanting said nanoparticle/nanotube residue.

13. The method as claimed in claim 1, wherein after step b) fullerenes are separated from said hydrocarbon liquid and soot by using an eluent followed by filtration through an 8-10 Å sieve.

14. Nanotubes comprising of shortened single walled nanotubes (sh-SWNTs) having a diameter of from 2 to 5 nm.

15. Nanotubes according to claim 14, wherein said shortened single walled nanotubes (sh-SWNTs) have a length of from 0.1 to 1 μm.

16. Nanotubes according to claim 15, wherein said shortened single walled nanotubes (sh-SWNTs) have a length of from 0.1 to 0.5 μm.

17. Nanotubes according to claim 14, wherein said shortened single walled nanotubes (sh-SWNTs) have 16 a diameter of from 2 to 3 nm.

18. Nanotubes comprising of shortened multi-walled nanotubes (sh-MWNTs) having a mean diameter of from 2 to 15 nm and a length of between 50 to 1000 nm.

19. Nanotubes according to claim 18, wherein said shortened multi-walled nanotubes (sh-MWNTs) have a median diameter of 60 to 80 Å and a length of 100 to 300 nm.

20. Nanotubes according to claim 18, wherein said shortened multi-walled nanotubes (sh-MWNTs) are constructed from 2 to 6 layers of SWNTs.

21. An apparatus for producing fullerenes, nanotubes or nanoparticles, said apparatus comprising:
a chamber capable of containing a liquid hydrocarbon reactant used to produce fullerenes, nanoparticles and nanotubes, said chamber containing at least one first electrode having a first polarity and at least one second electrode having a second polarity, said first and said second electrodes being arranged in proximity to one another and wherein a contactor is fixedly attached to said first electrode.

22. The apparatus as claimed in claim 21, wherein said contactor is made from tungsten, molybdenum or graphite.

23. The apparatus as claimed in claim 21, wherein said contactor is spherical.

24. The apparatus as claimed in claim 21, wherein said first electrode is made from tungsten, molybdenum or graphite.

25. The apparatus as claimed in claim 21, wherein said first electrode is rod-shaped.

26. The apparatus as claimed in claim 21, wherein said second electrode consists of a matrix having a plurality of cavities capable of receiving a first electrode.

27. The apparatus as claimed in claim 21, wherein said apparatus contains a gas inlet to allow gas to be supplied to an area at or near said electrodes.

28. The apparatus as claimed in claim 21, wherein said apparatus includes a cooling means.

29. The apparatus as claimed in claim 28 wherein, said cooling means includes a cavity wall in a wall of a chamber through which a coolant is circulated.

30. The apparatus as claimed in claim 21, wherein said chamber includes pressure regulation means for maintaining pressure inside said chamber at a pre-determined level.

31. A method of encapsulating a gas within a nanocarbon sample, said method comprising the following steps:
a) oxidizing said nanocarbon sample sufficiently to open one end of at least some of said nanotubes in said sample, and
b) impressing said gas into said opened nanotubes.

32. The method as claimed in claim 31, wherein said nanocarbon sample is oxidized at ambient temperature in acid for 30 to 120 minutes.

33. The method as claimed in claim 31, wherein said nanocarbon sample is oxidized at a temperature of from 350 and 650° C.

34. The method as claimed in claim 31, wherein said nanocarbon sample is oxidized by:
i) heating to a temperature of above 500° C. for 30 to 90 minutes;
ii) soaking said nanocarbon sample of step i) in hydrochloric, hydrofluoric or nitric acids for 10 to 24 hours; and
iii) heating said nanocarbon of step ii) to a temperature of about 600° C. for 30 to 120 minutes.

35. The method as claimed in claim 31, wherein said gas is impressed into said opened nanotubes by heating said nanocarbon to a temperature of 520° C. to 650° C. for up to 10 minutes in an atmosphere of said gas.

36. The method as claimed in claim 31, wherein said gas is impressed into said opened nanotubes by heating said nanocarbon sample to a temperature of 520° C. to 650° C., for up to 10 minutes, purging said heated sample in vacuo and then exposing said sample to said gas at a pressure of 70 atmospheres or higher.

37. The method as claimed claim 31, wherein said nanocarbon sample contains shortened nanotubes having a diameter of 1 μm or less.

38. The method as claimed in claim 31, wherein said gas is hydrogen, helium, argon, krypton, xenon or radioactive isotopes thereof.

39. A method of displacing a first gas encapsulated in a nanocarbon sample and replacing said first gas with a second gas, said method comprising heating said nanocarbon sample in vacuo and impressing said gas into said sample.

40. The method as claimed in claim 39, wherein said second gas is impressed into said nanocarbon sample at a pressure of approximately 70 to 150 atmospheres.
